(19) United States
(12) Patent Application Publication
(10) Pub. No.: US 2026/0211872 A1
(43) Pub. Date: Jul. 23, 2026

(54) AGENTIC SAFETY ASSISTANT MANAGER

(71) Applicant: NETRADYNE, INC., San Diego, CA (US)

(72) Inventors: David Jonathan Julian, Hendersonville, TN (US); Adam Thomas Lang, Superior, WI (US)

(73) Assignee: NETRADYNE, INC., San Diego, CA (US)

(21) Appl. No.: 19/447,802

(22) Filed: Jan. 13, 2026

Related U.S. Application Data
(60) Provisional application No. 63/746,847, filed on Jan. 17, 2025.

(51) Int. Cl. G06F 16/242; G06F 16/2453

(52) U.S. Cl. CPC G06F 16/243; G06F 16/24542

(57) ABSTRACT

Systems and methods of assisting fleet safety managers using agentic large language models are provided. A method for processing fleet safety queries using a two-model machine learning architecture. The method receives natural language queries regarding fleet safety data and analyzes each query using a first machine learning model to determine whether the query matches predetermined query patterns. Upon determining that a query does not match any predetermined patterns, the method generates a proposed data retrieval plan using a second machine learning model, identifies data sources required to fulfill the proposed plan, retrieves data from the identified sources, and generates a response including the retrieved data. The method provides supporting evidence links associated with factual assertions in the response, enabling verification of response accuracy against primary data sources.

### CROSS-REFERENCE TO RELATED APPLICATIONS

The present application claims the benefit of U.S. Provisional Ser. No. 63/746,847 filed on Jan. 17, 2025, and titled, “AGENTIC SAFETY ASSISTANT MANAGER”, the disclosure of which is expressly incorporated by reference in its entirety.

### TECHNICAL FIELD

Certain aspects of the present disclosure generally relate to systems and methods to enable fleet safety managers to work more efficiently, and more particularly to systems and methods of natural language interfaces powered by agentic large language models.

### BACKGROUND

Fleet safety managers have to juggle various tasks on the job to protect their fleets, including sifting through complex data to identify risks and opportunities for improvement.

While fleet management technology has evolved over the years, many solutions today still present limitations. Current fleet management technology can help fleet safety managers get the job done, but it has drawbacks.

### SUMMARY

Certain aspects of the present disclosure generally relate to providing, implementing, and using agentic LLMs.

Certain aspects of the present disclosure generally relate to systems, methods, and computer-readable media for processing natural language queries regarding fleet safety data using agentic large language model architectures. The disclosed embodiments address technical challenges associated with query processing efficiency, response accuracy verification, user interface adaptation, compliance guidance, and privacy-preserving knowledge sharing across fleet management systems.

In accordance with certain aspects, a method for processing fleet safety queries comprises receiving, at one or more processors, a natural language query regarding fleet safety data. The method includes analyzing, using a first machine learning model, whether the natural language query matches any predetermined query patterns. Upon determining the query does not match any predetermined patterns, the method includes generating, using a second machine learning model, a proposed data retrieval plan, identifying data sources required to fulfill the proposed plan, retrieving data from the identified sources, and generating a response including the retrieved data. The method further includes providing supporting evidence links associated with factual assertions in the response.

In certain embodiments, analyzing whether the natural language query matches any predetermined query patterns comprises generating a vector representation of the natural language query by encoding semantic features of the query into a multi-dimensional embedding space, comparing the vector representation against a query pattern database storing previously processed query vectors, and computing a similarity metric between the vector representation and each stored query vector.

In certain embodiments, generating the proposed data retrieval plan comprises generating a structured data retrieval plan specifying target database table, query parameters, join conditions linking disparate data sources, and temporal filters. Retrieving data from the identified sources may comprise executing the structured data retrieval plan to retrieve fleet safety data from a plurality of data sources, wherein the plurality of data sources comprises at least two of a GPS tracking database, a vehicle telemetry database, a video event database, or a driver performance database. The method may include integrating retrieved data from the plurality of data sources by correlating records based on temporal proximity and vehicle identifiers.

In certain embodiments, generating the response further comprises identifying, within the retrieved data, safety-related data elements, wherein safety-related data elements comprise at least one of collision event records, driver alert violations exceeding a severity threshold, hours-of-service compliance deviations, or vehicle maintenance fault codes. The method may include executing a verification operation against a primary data source to confirm accuracy of each identified safety-related data element and generating a confidence indicator for each safety-related data element based on verification results.

In certain embodiments, the method further comprises analyzing a complexity score for the natural language query based on a count of distinct data sources required to fulfill the query, a count of distinct entity types referenced, and a count of temporal constraints specified. In response to the complexity score exceeding a complexity threshold, the method may include identifying temporal relationships between data records from different sources based on timestamp alignment within a configurable temporal window, detecting data inconsistencies across sources by comparing overlapping data fields, and generating a data consistency score for integrated retrieved data.

In certain embodiments, the method further comprises storing the proposed data retrieval plan in a query pattern database for subsequent pattern matching operations. Storing may comprise extracting analysis parameters from the natural language query comprising entity types, temporal ranges, and aggregation functions, recording metadata identifying each data source accessed, and associating verification requirements with the stored plan based on data sensitivity classifications.

In certain embodiments, the method further comprises detecting, from the natural language query, a request for time-sensitive safety information based on presence of urgency indicators. In response to detecting the request for time-sensitive safety information, the method may include routing the query to a dedicated processing pathway configured to bypass pattern matching and directly access real-time data feeds.

In certain embodiments, the response further comprises uncertainty indicators for assertions lacking corresponding source records, wherein each uncertainty indicator includes explanatory text indicating data limitations.

In certain embodiments, the method further comprises receiving feedback data indicating user assessment of the response and adjusting a relevance weight associated with query patterns based on the feedback data.

In accordance with certain aspects, a system for processing fleet safety queries comprises one or more processors and a memory coupled to the one or more processors. The memory stores instructions that, when executed by the one or more processors, cause the system to receive a natural language query regarding fleet safety data, analyze using a first machine learning model whether the natural language query matches any predetermined query patterns, and upon determining the query does not match any predetermined patterns, generate using a second machine learning model a proposed data retrieval plan, identify data sources required to fulfill the proposed plan, retrieve data from the identified sources, and generate a response including the retrieved data. The instructions further cause the system to provide supporting evidence links associated with factual assertions in the response.

In accordance with certain aspects, a non-transitory computer-readable medium stores instructions that, when executed by one or more processors, cause the one or more processors to perform operations comprising receiving a natural language query regarding fleet safety data, analyzing using a first machine learning model whether the natural language query matches any predetermined query patterns, and upon determining the query does not match any predetermined patterns, generating using a second machine learning model a proposed data retrieval plan, identifying data sources required to fulfill the proposed plan, retrieving data from the identified sources, and generating a response including the retrieved data. The operations further comprise providing supporting evidence links associated with factual assertions in the response.

In accordance with certain aspects, the method further comprises, subsequent to generating the response, storing the natural language query in a query tracking database associated with a fleet identifier of an originating fleet management terminal. The method includes periodically analyzing the query tracking database to identify query patterns that exceed a predetermined frequency threshold across a plurality of fleet management terminals, generating user interface component specifications based on the identified query patterns, computing a cluster priority score for each identified query pattern based on a weighted combination of cluster size, aggregate fleet size of contributing fleets, and aggregate safety performance scores of contributing fleets, and ranking generated user interface component specifications by cluster priority score.

In certain embodiments, computing the cluster priority score comprises retrieving, for each fleet contributing queries to a query pattern cluster, a computed safety score derived from collision rates, alert frequencies, and compliance metrics, and applying elevated weighting to query contributions from fleets having safety scores exceeding a performance threshold. The elevated weighting enables the system to learn preferentially from high-performing fleets that exemplify industry best practices.

In certain embodiments, the method further comprises determining fleet similarity between fleets associated with the plurality of fleet management terminals by representing each fleet profile as a vector encoding fleet size category, operational category, primary geographic region, and cargo type classification. The method includes computing a distance metric between fleet profile vectors and distributing generated user interface component specifications to fleet management terminals associated with fleets having distance metrics below a similarity threshold, thereby targeting interface improvements to operationally similar fleets most likely to benefit from identified query patterns.

In accordance with certain aspects, the method further comprises, prior to generating the response, analyzing the natural language query to determine whether requested analysis complies with predetermined operational guidelines. Analyzing comprises parsing the natural language query to identify requested analysis parameters comprising target data fields, aggregation dimensions, and filter criteria, comparing the requested analysis parameters against a compliance rule database storing prohibited analysis patterns, and generating a compliance risk score based on matching between requested analysis parameters and prohibited analysis patterns. In response to the compliance risk score exceeding a compliance threshold, the method includes generating an alternative query that achieves safety-related analytical objectives while avoiding prohibited analysis patterns and processing the alternative query in place of the natural language query. The method further comprises logging the natural language query, compliance assessment, and the response in an audit database.

In certain embodiments, the method further comprises analyzing terminology used in the natural language query against a terminology guidance database storing term pairs comprising disfavored terms and preferred alternative terms. The method includes detecting presence of disfavored terms in the natural language query, generating a terminology suggestion comprising the preferred alternative term and an explanatory rationale, and presenting the terminology suggestion prior to generating the response. The terminology guidance database may store term pairs comprising a first term pair mapping a collision-related disfavored term to a preferred neutral term and a second term pair mapping a driver qualification disfavored term to a preferred standard-of-care-neutral term. Such terminology guidance assists fleet safety managers in maintaining documentation practices that reduce potential liability exposure during legal discovery proceedings.

In accordance with certain aspects, the method further comprises, subsequent to generating the response, computing a query abstraction of the natural language query that preserves analytical intent while removing fleet-identifying information. Computing the query abstraction comprises extracting semantic features from the natural language query, identifying named entities in the natural language query comprising driver names, vehicle identifiers, location names, and customer references, replacing identified named entities with categorical tokens indicating entity type without specific identity, and normalizing numerical values referenced in the natural language query to categorical ranges. The method includes storing the query abstraction in a community knowledge database aggregating abstracted query representations from a plurality of fleet management systems.

In certain embodiments, the method further comprises periodically analyzing the community knowledge database to identify high-value query patterns based on correlation between query patterns and fleet safety performance improvements. Identifying comprises tracking safety performance metrics for fleets subsequent to query submission, computing correlation coefficients between query pattern occurrence and safety metric improvements, and classifying query patterns having correlation coefficients exceeding a correlation threshold as high-value query patterns.

In certain embodiments, the method further comprises identifying source fleets having safety performance metrics in a top performance tier, applying elevated weighting to queries from top-tier fleets when computing correlation coefficients, generating best-practice query collections comprising high-value query patterns predominantly contributed by top-tier fleets, and transmitting suggested query templates derived from the best-practice query collections to target fleet management systems based on contextual applicability criteria. This approach enables fleet safety managers across the industry to benefit from analytical approaches developed by the highest-performing fleets while maintaining strict privacy boundaries that prevent identification of contributing fleets or their specific operational data.

The disclosed embodiments provide several technical advantages over conventional fleet management systems. The two-model query processing architecture enables efficient handling of both recurring query patterns and novel analytical requests, reducing response latency for common queries while maintaining flexibility for complex, unprecedented analyses. The evidence linking mechanism addresses the technical challenge of hallucination in large language model outputs by providing verifiable source references for factual assertions, enabling fleet safety managers to validate response accuracy against primary data sources.

The adaptive user interface generation system creates a technical feedback loop wherein query patterns from high-performing fleets inform interface development priorities, resulting in user interfaces that evolve based on demonstrated analytical value rather than speculative feature requests. The safety score weighting mechanism ensures that interface improvements reflect best practices from fleets with proven safety outcomes.

The compliance and terminology guidance system provides automated safeguards against potentially problematic analyses while offering educational guidance on documentation terminology, addressing the technical challenge of ensuring query system outputs remain appropriate for legal and regulatory contexts. The query transformation mechanism enables the system to redirect non-compliant queries toward behavior-specific analyses that achieve underlying safety objectives.

The privacy-preserving community learning system addresses the technical challenge of enabling cross-fleet knowledge sharing while maintaining strict data isolation. The query abstraction mechanism employs natural language processing techniques to remove identifying information while preserving analytical intent, enabling aggregation of query patterns across organizational boundaries without exposing proprietary operational details.

In certain embodiments, the pre-response processing components, including compliance analysis and terminology guidance, may operate as a standalone layer applicable to various query processing architectures. In certain embodiments, the post-response processing components, including adaptive user interface generation and community learning, may operate independently of the specific query processing implementation described herein, receiving query data from alternative fleet management systems. Such modularity enables deployment flexibility while maintaining the technical benefits of each component.

### BRIEF DESCRIPTION OF THE DRAWINGS

Non-limiting embodiments of the present disclosure are described by way of example with reference to the accompanying figures, which are schematic and are not intended to be drawn to scale. Unless indicated as representing the background art, the figures represent aspects of the disclosure. For purposes of clarity, not every component may be labeled in every drawing. In the drawings:

FIG. 1 illustrates a system architecture for processing fleet safety queries in accordance with certain aspects of the present disclosure.

FIG. 2 illustrates a method for processing fleet safety queries in accordance with certain aspects of the present disclosure.

FIG. 3 illustrates a query processing module comprising first and second machine learning models in accordance with certain aspects of the present disclosure.

FIG. 4 illustrates pre-response processing including compliance analysis and terminology guidance in accordance with certain aspects of the present disclosure.

FIG. 5 illustrates post-response processing for adaptive user interface generation in accordance with certain aspects of the present disclosure.

FIG. 6 illustrates post-response processing for privacy-preserving community learning in accordance with certain aspects of the present disclosure.

FIG. 7 illustrates an integrated query processing flow showing temporal relationships between processing phases in accordance with certain aspects of the present disclosure.

FIG. 8 illustrates data sources and integration for fleet safety query processing in accordance with certain aspects of the present disclosure.

FIG. 9 illustrates a two-model architecture for pattern matching and retrieval plan generation in accordance with certain aspects of the present disclosure.

FIG. 10 illustrates fleet similarity determination using profile vector encoding in accordance with certain aspects of the present disclosure.

FIG. 11 illustrates a safety score weighting system for priority scoring in accordance with certain aspects of the present disclosure.

FIG. 12 illustrates a terminology guidance system for query analysis in accordance with certain aspects of the present disclosure.

FIG. 13 illustrates evidence link generation for response verification in accordance with certain aspects of the present disclosure.

### DETAILED DESCRIPTION

Current fleet management systems have limitations. Notably, typical fleet management tools offer minimal options for customization and flexibility. Additionally, their analytical capabilities are limited to predeveloped report formats. They tend not to be very interactive either, making it difficult or impossible for fleet safety managers to interact with them beyond the confines of their existing user experience (UX). For instance, a fleet management tool might alert a manager every time drivers don't stop at a red light, but it might not make it possible for the manager to drill down and see what other factors might be at play when drivers end up running red lights, such as weather, traffic density and stale green lights. Such information may be useful for driver safety training purposes, including coaching decisions about which drivers and topic areas should be prioritized for coaching.

As disclosed herein, natural language interfaces powered by agentic LLMs can overcome certain limitations of current fleet management systems. Certain aspects of the present disclosure may give fleet safety managers a greater degree of analysis, customization and flexibility, enabling them to use data more strategically to protect everyone's safety on the road.

Emerging technology—natural language interfaces powered by agentic LLMs—can be configured in accordance with the present disclosure to give fleet safety managers more options for analysis, customization and flexibility. Agentic LLMs formed with pretrained LLMs may be more improved than traditional non-agentic artificial intelligence interfaces at least because they can plug into other applications, databases, and the like, and may therefore evaluate multi-modal information (such as GPS data, dash cam footage and vehicle telemetry). They may also, or alternatively, provide insights and make recommendations as prompted. Configured in these ways, LLM assistants enable fleet safety managers to go beyond the existing point-and-click UX and tap into the potential of the underlying data, not just what's visible in standard reports.

Where a point-and-click interface might limit managers to predefined views, an agentic LLM can parse complex, multi-source information, connect disparate data points and generate refined insights that might otherwise remain hidden within vast amounts of fleet data. Moreover, an LLM interface can enable managers to iteratively interact with the data—specifically, by giving them the opportunity to ask follow-up questions.

Some questions a fleet safety manager might ask an LLM assistant include: “Could you please create a list of all my drivers who have run at least five red lights in the last month?” “Which of my vehicles have low tire pressure?” “Where in the route is driver Jane Doe currently?” “Based on your analysis of individual drivers, which are most in need of coaching?” “What are the top three risky behaviors exhibited by driver John Doe in the past month, and what are the top three areas of good driving?” “We received a customer complaint that one of our drivers may have hit a mailbox at 123 Main Street in the last 24 hours. Could you identify any potential vehicles it might have been?” “Which of my vehicles are most prone to flooding, based on their location, terrain they frequently drive on and history of water-related incidents?”

The answers to these questions and more can assist fleet safety managers with coaching, route assignments and other calls they need to make to increase safety and efficiency. They can also help fleet safety managers identify systemic issues, such as tricky intersections, that need to be addressed. For instance, based on the response to the question, “Which of my vehicles are most prone to flooding, based on their location, terrain they frequently drive on and history of water-related incidents?” an LLM can identify the vehicles most at risk, and on rainy days, a fleet manager can avoid putting those vehicles on the road. Or based on the response to the question, “What are the top three risky behaviors exhibited by driver John Doe in the past month, and what are the top three areas of good driving?,” a fleet safety manager can determine what feedback to give John Doe.

The iterative, interactive nature of agentic LLMs enables fleet safety managers to ask follow-up questions and drill down into data beyond what's possible with a tool that leverages a traditional UX. So, in this case, the fleet safety manager could ask, “What are the key points I should emphasize when giving the feedback?” or “May you help me put together a comprehensive training program for John Doe based on these identified areas?” After the coaching begins, the fleet safety manager can ask the LLM follow-up questions to gauge the effectiveness of the program, such as “May you analyze the driver's current performance, compare it to what it was three months ago, and identify which areas need the most improvement?”

Moreover, since fleet managers have more flexibility in how they interact with agentic LLMs and don't have to manually connect the dots in the data, they can streamline processes at their company, leading to quicker decisions. A fleet safety manager can create generic triggers, building on a small script that instructs an agentic LLM to track and generate a type of alert. For instance, a fleet safety manager could create a trigger for tire pressure and tell the agentic LLM, “Please track the tire pressure of my vehicles, and if the pressure drops below 85 psi or above 120 psi, please send an alert to the maintenance shop and include the vehicle's number and its tire pressure.” Additionally, if agentic solutions are built on pretrained LLMs and LGMs fused with driving data, fleet safety managers can swiftly access other data, such as DMV manuals and severe weather safety tips.

While this new technology enables fleet safety managers to do more with data, it poses some challenges.

For one, natural language interfaces powered by agentic LLMs often need to retrieve substantial amounts of information from various databases, which can take 10 to 30 seconds—a slower response time than a traditional UX that might be highly optimized, or even in comparison to non-agentic LLMs. Fleet safety managers should be mindful of these delays, although as discussed below, certain queries may be selected and responses to them optimized so that these delays may be reduced, at least for common or high value queries. Additionally, as with any AI solution, there's the risk of inaccurate outputs. To safeguard against this, LLMs may be configured to provide source references for their statements that allow users to validate the responses. Additionally, these systems may have processes in place to identify and address the potential for inaccurate information. For instance, during the pre-prompt design stage, engineers can dictate that an LLM states, “This is out of scope,” for questions that are out of scope, and says “I don't know” if it's not sure what to say.

If LLMs are configured so that they are more reliable, which may mean that the LLMs sometimes reply that they do not know the answer, fleet safety managers will be able to depend on them to work faster and more strategically to protect everyone on the road.

The present disclosure addresses the technical challenges described above through a query processing architecture that employs two machine learning models operating in sequence. A first machine learning model analyzes whether an incoming natural language query matches any predetermined query patterns stored in a pattern database. When a match is found, the system executes a retrieval template associated with the matched pattern, enabling rapid response for recurring query types and addressing the response latency challenge. When no match is found, a second machine learning model generates a proposed data retrieval plan that specifies target database tables, query parameters, join conditions linking disparate data sources, and temporal filters. This two-model architecture balances response efficiency for common queries with analytical flexibility for new requests.

The first machine learning model generates a vector representation of the natural language query by encoding semantic features of the query into a multi-dimensional embedding space. Semantic features comprise linguistic characteristics extracted from the query including word meanings, phrase relationships, syntactic structures, and contextual intent indicators. The multi-dimensional embedding space comprises a numerical representation having a predetermined number of dimensions, such as 768 or 1024 dimensions, wherein each dimension captures a learned aspect of query semantics. The system compares this vector representation against a query pattern database storing previously processed query vectors and computes a similarity metric between the vector representation and each stored query vector using distance measures such as cosine similarity or Euclidean distance. When the similarity metric exceeds a predetermined similarity threshold for a stored query vector, the system retrieves and executes the corresponding retrieval template. The similarity threshold for query pattern matching defines a minimum similarity value above which an incoming query is considered to match a stored pattern. For example, a similarity threshold of 0.85 cosine similarity indicates that queries must share substantial semantic overlap with stored patterns to trigger template execution. Higher thresholds reduce false positive matches but may result in more queries requiring full plan generation.

The second machine learning model generates a structured data retrieval plan that identifies data sources required to fulfill the query. The structured data retrieval plan specifies query parameters comprising specific values or ranges used to filter data, such as date ranges, driver identifiers, vehicle identifiers, alert type codes, geographic boundaries, and threshold values. The system retrieves fleet safety data from a plurality of data sources comprising at least two of a GPS tracking database, a vehicle telemetry database, a video event database, or a driver performance database. The system integrates retrieved data from these data sources by correlating records based on temporal proximity and vehicle identifiers.

After generating a response, the system stores the new query pattern and retrieval plan in the pattern database for subsequent pattern matching operations. Storing comprises extracting analysis parameters from the natural language query comprising entity types, temporal ranges, and aggregation functions, recording metadata identifying each data source accessed, and associating verification requirements with the stored plan based on data sensitivity classifications. Entity types comprise categories of objects referenced in queries including drivers, vehicles, locations, time periods, alert categories, customer accounts, routes, and organizational units such as terminals or divisions. Aggregation functions comprise computational operations applied to data sets including summation (SUM), counting (COUNT), averaging (AVG), minimum determination (MIN), maximum determination (MAX), and statistical measures such as standard deviation. Data sensitivity classifications comprise categories indicating the confidentiality or criticality of data elements. For example, driver identification information and facial recognition data may be classified as high sensitivity, while aggregate fleet statistics may be classified as low sensitivity. Verification requirements comprise validation operations associated with stored plans, such as mandatory source confirmation for safety-related assertions, human review triggers for personnel-related analyses, and cross-reference checks for compliance-sensitive data.

To address the risk of inaccurate outputs described above, the system provides supporting evidence links associated with factual assertions in the response. The system identifies safety-related data elements within retrieved data, wherein safety-related data elements comprise at least one of collision event records, driver alert violations exceeding a severity threshold, hours-of-service compliance deviations, or vehicle maintenance fault codes. A severity threshold defines a minimum level of significance for alert violations warranting special handling during response generation. Severity may be quantified based on potential safety impact, frequency of occurrence within a defined period, regulatory implications, or deviation magnitude from acceptable parameters. For example, a hard braking severity threshold may correspond to deceleration rates exceeding a predetermined value such as 8.5 feet per second squared, while a following distance severity threshold may correspond to headway times below a predetermined duration such as 1.0 second. Severity thresholds may be configured by fleet operators based on organizational safety policies and may differ across alert categories.

For each identified safety-related data element, the system executes a verification operation against a primary data source to confirm accuracy and generates a confidence indicator based on verification results. A verification operation comprises a validation process that confirms data accuracy by querying authoritative source systems. For example, verification of a collision event record may comprise retrieving the original event record from the video database and confirming event timestamp, location, and classification. A primary data source comprises the authoritative system of record for a particular data type, as distinguished from derived or aggregated data stores. For example, the video event database serves as the primary data source for collision events, while the GPS database serves as the primary data source for vehicle location records. A confidence indicator comprises a quantitative or qualitative measure indicating the reliability of a data element or assertion. Confidence indicators may be expressed as numerical scores on a predetermined scale, such as 0.0 to 1.0, or as categorical levels such as “verified,” “partially verified,” or “unverified.” The confidence indicator may be displayed to users alongside relevant assertions to inform reliance decisions

The system analyzes a complexity score for the natural language query based on a count of distinct data sources required to fulfill the query, a count of distinct entity types referenced, and a count of temporal constraints specified. Temporal constraints comprise time-related specifications in queries including explicit date ranges such as “January 1 through January 31,” relative time references such as “last 30 days” or “since Monday,” time windows such as “between 6 AM and 9 AM,” recurrence patterns such as “every Monday,” and duration specifications such as “trips longer than 4 hours.” A complexity threshold defines a boundary above which queries receive enhanced multi-source integration processing. For example, a complexity threshold may be triggered when a query requires data from more than three distinct data sources, references more than five distinct entity types, or specifies temporal constraints spanning non-contiguous time periods. The complexity score may be computed as a weighted sum of the individual counts, with weights reflecting the processing overhead associated with each complexity factor.

When the complexity score exceeds the complexity threshold, the system identifies temporal relationships between data records from different sources based on timestamp alignment within a configurable temporal window, detects data inconsistencies across sources by comparing overlapping data fields, and generates a data consistency score for integrated retrieved data. A configurable temporal window defines a time range within which records from different data sources are considered temporally related for correlation purposes. The window size may be configured based on data source characteristics and analytical requirements. For example, correlating GPS position data with video event records may employ a temporal window of plus or minus 5 seconds to account for timestamp synchronization variations between systems, while correlating daily summary metrics may employ a temporal window of plus or minus 24 hours. Overlapping data fields comprise data elements that appear in multiple source systems and may be compared for consistency, such as vehicle speed values present in both GPS records and telemetry records, or location coordinates present in both GPS records and alert records. Data inconsistencies may include conflicting speed values, mismatched location coordinates, contradictory alert status indicators, or incompatible timestamp sequences. A data consistency score quantifies the degree of agreement between overlapping fields from different sources, computed as a ratio of consistent field comparisons to total field comparisons, expressed as a value between 0.0 indicating complete inconsistency and 1.0 indicating complete consistency.

For queries requesting time-sensitive safety information, the system detects urgency indicators in the natural language query and routes the query to a dedicated processing pathway configured to bypass pattern matching and directly access real-time data feeds. Time-sensitive safety information comprises data requiring immediate access due to operational urgency, including current vehicle locations, active alert statuses, ongoing incident information, and real-time compliance states. Urgency indicators comprise linguistic markers within the natural language query indicating time-sensitive information requests, including temporal adverbs such as “now,” “immediately,” “currently,” or “right now”; question phrases indicating real-time status such as “where is,” “what is the current,” or “is there an active”; references to ongoing events such as “in progress,” “happening,” or “live”; and explicit urgency qualifiers such as “urgent,” “emergency,” “critical,” or “ASAP.” The dedicated processing pathway comprises a query execution route optimized for low-latency response, bypassing pattern matching lookup and cache operations to directly query real-time data feeds. Real-time data feeds comprise streaming or frequently-updated data sources including live GPS position streams providing vehicle locations at intervals such as every 10 seconds, active alert queues containing unacknowledged safety events, current hours-of-service status from electronic logging device integrations, and live vehicle diagnostic streams.

The system receives feedback data indicating user assessment of the response and adjusts a relevance weight associated with query patterns based on the feedback data. Feedback data comprises user input indicating satisfaction or dissatisfaction with generated responses, captured through mechanisms including binary indicators such as thumbs-up or thumbs-down selections, numerical ratings on predetermined scales such as 1-5 stars, explicit textual feedback, and implicit behavioral signals such as query reformulation or response dismissal. A relevance weight comprises a numerical factor associated with stored query patterns that influence pattern matching priority and template selection. Positive feedback increases the relevance weight of associated patterns, causing those patterns to be preferentially matched for similar future queries. Negative feedback decreases the relevance weight, potentially causing patterns to be bypassed in favor of fresh plan generation. This feedback mechanism enables continuous improvement of query pattern matching based on actual user experience.

In accordance with certain aspects, the system analyzes patterns in user queries to identify opportunities for UX improvements. This analysis can be performed across multiple dimensions to determine which query types warrant development of standardized UX features, as standardized UX features may operate faster and simply having features standardized makes them more likely to be used by users. Queries may be classified according to their relation to alert types, such as drowsy driving or following distance alerts, or their connection to components of standardized scoring systems. The system can also classify queries based on industry vertical, such as hazmat transport, refrigerated cargo, or local delivery operations. Geographic considerations may be relevant, as fleets operating in different regions face distinct challenges, such as northern winter driving conditions that affect safety protocols and operational decisions.

Subsequent to generating the response, the system stores the natural language query in a query tracking database associated with a fleet identifier of the originating fleet management terminal. The system periodically analyzes the query tracking database to identify query patterns that exceed a predetermined frequency threshold across a plurality of fleet management terminals. A predetermined frequency threshold defines a minimum occurrence count above which query patterns are considered candidates for user interface development. For example, a frequency threshold of 50 occurrences per month across participating fleets may indicate sufficient demand to warrant dedicated interface development. The frequency threshold may be adjusted based on total system query volume and development resource availability.

For identified patterns, the system generates user interface component specifications and computes a cluster priority score for each identified query pattern based on a weighted combination of cluster size, aggregate fleet size of contributing fleets, and aggregate safety performance scores of contributing fleets. User interface component specifications comprise technical definitions for interface elements addressing identified query patterns, including dashboard widgets displaying frequently-requested metrics, report templates providing standardized analysis formats, interactive filters enabling common data segmentation operations, and shortcut buttons executing frequent query types. The specifications may include layout parameters, data binding definitions, refresh intervals, and user customization options.

The system applies elevated weighting to query contributions from fleets having safety scores exceeding a performance threshold, wherein the safety scores are derived from collision rates, alert frequencies, and compliance metrics. A performance threshold defines a safety score value above which fleets are classified as high-performing for weighting purposes. The performance threshold may be established as a percentile rank, such as the 75th percentile of safety scores across participating fleets, or as an absolute score value, such as a score of 800 on a standardized 1000-point scale. Compliance metrics may include hours-of-service violation rates, inspection pass rates, regulatory citation frequencies, and policy adherence scores. Elevated weighting comprises increased multipliers applied to query contributions from high-performing fleets. For example, queries from fleets exceeding the performance threshold may receive a weighting multiplier of 1.5, while queries from other fleets receive a baseline multiplier of 1.0. This weighting mechanism enables the system to learn preferentially from high-performing fleets that exemplify industry best practices.

In certain embodiments, the system determines similarity between fleets based on multiple factors which may include one or more of fleet size, typical routes, cargo types, and operational patterns. This similarity analysis enables identification of query patterns that may be relevant across seemingly different fleet types. For instance, queries about adverse weather handling might be relevant across multiple verticals operating in the same region, while fuel efficiency queries might group differently based on route types and vehicle categories.

The system determines fleet similarity between fleets associated with the plurality of fleet management terminals by representing each fleet profile as a vector encoding fleet size category, operational category, primary geographic region, and cargo type classification. Fleet size categories comprise predetermined ranges classifying fleets by vehicle count, such as small fleets having fewer than 50 vehicles, medium fleets having 50 to 500 vehicles, and large fleets having more than 500 vehicles. Operational categories comprise classifications based on transportation service characteristics, such as long-haul operations typically exceeding 500 miles per trip, regional operations within a multi-state area, local operations within a metropolitan area, dedicated contract carriage, and for-hire versus private fleet designations. Operational categories may further distinguish truckload from less-than-truckload operations. Primary geographic region comprises the predominant operating territory of a fleet, which may be encoded at various granularity levels including national regions such as Northeast, Southeast, Midwest, Southwest, and West Coast, state-level designations, or climate zones affecting operational considerations such as winter weather exposure. Cargo type classifications comprise categories of goods transported, including general freight, refrigerated goods requiring temperature control, hazardous materials requiring special handling certifications, bulk commodities, flatbed cargo, and passenger transport including school buses and transit vehicles.

The system computes a distance metric between fleet profile vectors using measures such as Euclidean distance, cosine distance, or weighted distance measures that emphasize operationally significant attributes. The system distributes generated user interface component specifications to fleet management terminals associated with fleets having distance metrics below a similarity threshold. The similarity threshold for fleet grouping defines a maximum distance value below which fleets are considered operationally similar for resource sharing purposes. For example, a similarity threshold of 0.3 Euclidean distance creates relatively homogeneous fleet groupings sharing multiple operational characteristics, while a threshold of 0.5 creates broader groupings with more diverse membership. The threshold may be configured separately for different distribution purposes, with tighter thresholds for specialized resources and broader thresholds for general resources.

To prioritize which query patterns warrant UX development, the system may implement various weighting mechanisms. Queries from larger fleets may receive higher priority due to their broader impact. Additionally, the system may assign higher weight to queries from fleets demonstrating superior safety scores, as these fleets often exemplify best practices in the industry. Queries from recognized industry experts, such as advisory board members, may receive special consideration as they often identify emerging needs in the industry. The system may also examine correlation between query patterns and utilization of existing features to identify areas where current UX capabilities may be insufficient.

In certain embodiments, the system tracks success of query responses through one or more mechanisms, including direct user feedback and/or usage metrics. When users frequently repeat similar queries, this may indicate a need for dedicated UX features. User interaction patterns, such as follow-up questions or query refinements, provide insight into the completeness and utility of responses. Follow-up questions submitted within a predetermined time window, such as 5 minutes of the initial response, may indicate that the initial response was incomplete or required clarification. Query refinements comprising modified versions of previous queries may indicate that the initial query formulation was suboptimal or that the response did not address the user's actual intent. The system also monitors which queries lead to downloads or saved responses, indicating particularly valuable information paths. Downloaded responses and pinned queries represent explicit user endorsement of response value, and patterns in download behavior may inform prioritization of interface development efforts.

For critical data elements, the system may implement special handling procedures. Critical data may include time-sensitive safety information requiring immediate attention such as active collision alerts or breakdown notifications, data affecting scoring or compliance metrics such as hours-of-service violations or safety score adjustments, driver identification information including names and identification numbers, and vehicle status information requiring immediate action such as critical fault codes or out-of-service conditions. When processing queries involving critical data, the system may route these through dedicated non-LLM processing pathways that employ deterministic logic rather than probabilistic language model outputs, apply additional verification steps including cross-reference validation against multiple source systems, require human review for certain response types such as personnel action recommendations, and maintain detailed audit trails of data access and usage including user identity, timestamp, data elements accessed, and response content delivered.

The system includes safeguards regarding certain query types that could raise privacy or legal concerns. For instance, the system may identify potentially discriminatory analyses and suggest alternative approaches focused on specific safety behaviors rather than demographic factors.

Prior to generating a response, the system analyzes the natural language query to determine whether requested analysis complies with predetermined operational guidelines. The system parses the natural language query to identify requested analysis parameters comprising target data fields, aggregation dimensions, and filter criteria. Target data fields comprise specific data elements requested in the query, such as driver names, alert counts, location histories, or performance scores. Aggregation dimensions comprise grouping criteria for data summarization, such as aggregation by driver, by vehicle, by time period, by geographic region, or by alert type. Filter criteria comprise conditions limiting the scope of retrieved data, such as date range restrictions, driver subset specifications, alert severity minimums, or geographic boundaries.

The system compares the requested analysis parameters against a compliance rule database storing prohibited analysis patterns and generates a compliance risk score based on matching between requested analysis parameters and prohibited analysis patterns. Prohibited analysis patterns comprise query structures or parameter combinations that may violate operational guidelines, employment regulations, or organizational policies. Examples of prohibited analysis patterns include queries requesting demographic breakdowns of driver performance that could enable discriminatory treatment, queries correlating protected characteristics such as age or gender with safety metrics, queries that could facilitate disparate impact in personnel decisions, and queries requesting personally identifiable information without legitimate operational purpose. The compliance risk score quantifies the degree to which requested analysis matches prohibited patterns, computed as a weighted sum of pattern matches with weights reflecting regulatory severity and organizational risk tolerance.

When the compliance risk score exceeds a compliance threshold, the system generates an alternative query that achieves safety-related analytical objectives while avoiding prohibited analysis patterns and processes the alternative query in place of the original natural language query. A compliance threshold defines a risk score value above which queries are redirected to alternative processing. A lower compliance threshold, such as 0.3 on a normalized scale, results in more conservative query handling with more frequent redirections, while a higher compliance threshold, such as 0.7, permits broader query acceptance. The threshold may be configured by organizational administrators based on regulatory environment and risk tolerance. Safety-related analytical objectives comprise legitimate analysis goals focused on operational safety improvement, including identifying specific behaviors requiring coaching intervention, detecting patterns in safety incidents to inform training priorities, evaluating effectiveness of safety programs, monitoring compliance with operational policies, and benchmarking performance against organizational targets.

The system may also provide guidance on appropriate terminology for safety and legal documentation, helping users avoid problematic language that could create liability issues in future legal proceedings. For example, the system might suggest using “collision” rather than “crash” when describing incidents, as such terminology choices may be more precise and more likely to lead to analytical examination of the event.

The system analyzes terminology used in the natural language query against a terminology guidance database storing term pairs comprising disfavored terms and preferred alternative terms. The system detects presence of disfavored terms in the natural language query and generates a terminology suggestion comprising the preferred alternative term and an explanatory rationale. The explanatory rationale describes the basis for the recommendation of terminology, which may reference documentation best practices, industry standards, legal considerations, or specific regulatory guidance.

The terminology guidance database stores term pairs comprising a first term pair mapping a collision-related disfavored term to a preferred neutral term and a second term pair mapping a driver qualification disfavored term to a preferred standard-of-care-neutral term. For example, the first term pair may map the disfavored term “crash” to the preferred term “collision,” as the term “crash” may carry negative connotations suggesting fault or severity in legal proceedings, while “collision” represents a more neutral characterization amenable to objective analysis of contributing factors. The second term pair may map the disfavored term “professional driver” to the preferred term “driver,” as characterizing drivers as “professional” may imply an elevated standard of care in legal contexts that increases liability exposure when incidents occur. Additional term pairs may address severity-related terminology such as mapping “accident” to “incident,” fault-related terminology such as mapping “caused” to “involved in,” and characterization terminology such as mapping “reckless” to “at-risk behavior.” The terminology guidance database may be updated based on legal guidance, regulatory changes, and analysis of terminology patterns in litigation proceedings.

Through these mechanisms, the system continuously improves its ability to handle fleet safety queries while maintaining appropriate safeguards and focusing development efforts on the most valuable improvements. The system's ability to learn from query patterns while respecting privacy and legal considerations enables fleet safety managers to work more efficiently while avoiding potential pitfalls in documentation and analysis.

According to certain aspects, the system may identify patterns in how the most successful fleets utilize the query interface. Fleet success may be measured through various metrics including safety scores, compliance rates, and continuous improvement trends. The system may track not just what these high-performing fleets query, but how they interact with the data over time. For instance, some fleets demonstrate continuous improvement by regularly monitoring specific metrics and adjusting their practices based on the insights gained.

However, the system also recognizes potential drawbacks of unlimited query capabilities. While data analysis generally leads to improvement, excessive focus on certain metrics might lead to diminishing returns or distract from more important safety considerations. Therefore, the system may provide guidance about which queries have historically led to meaningful improvements in fleet safety metrics.

The system may also assist users in maintaining appropriate documentation practices. When users submit queries about safety incidents or driver behavior, the system may suggest terminology that aligns with industry best practices for documentation. This capability helps ensure that query responses and resulting documentation maintain appropriate professional standards and avoid potentially problematic language.

Integration with existing fleet management tools provides additional context for query handling. For instance, when users query about hours of service compliance, the system can integrate this information with other performance metrics such as fuel efficiency or safety scores. This integration helps identify patterns that might not be apparent when examining metrics in isolation. The system may also track which queries tend to lead to actionable insights versus those that primarily confirm existing knowledge.

The system maintains flexibility to address unique fleet characteristics while identifying common patterns across similar operations. For instance, different types of trucking operations such as less than truckload versus truckload, or regional versus long-haul-may benefit from different types of analyses. The system can recognize these operational differences while still identifying insights that may be valuable across categories.

In accordance with certain aspects, the system implements comprehensive operational guidelines for data analysis and query processing. These guidelines may specifically address employment law compliance, ensuring that analyses do not enable discriminatory practices even unintentionally. For instance, when analyzing driver performance data, the system focuses queries on specific safety behaviors and operational metrics rather than demographic or protected class information. The system may be configured to maintain strict data privacy requirements, particularly regarding driver identification information and personal data.

The system may include specific review triggers for sensitive analyses. Certain types of queries, such as those involving personnel decisions or systematic performance comparisons, may require additional validation steps or human review before responses are provided. For example, if a query could potentially surface patterns related to protected categories under employment law, the system redirects the analysis toward objective safety metrics and behavioral patterns.

When handling potentially sensitive queries, the system may implement a multi-step validation process: first identifying whether the query involves protected categories or sensitive information, then determining if the requested analysis can be reformulated to focus on specific safety behaviors, and finally generating alternative approaches that achieve the safety-related goals while maintaining compliance with relevant regulations. All such redirections and alternative analyses may be logged in an audit trail, enabling review of how sensitive queries are handled and helping refine the system's operational guidelines over time.

The system may maintain detailed records of query processing decisions, including the basis for redirecting certain types of analyses, the alternative approaches suggested, and any human review decisions made. This documentation helps ensure consistent application of operational guidelines while providing transparency about how potentially sensitive analyses are handled. The audit trail includes not only the queries and responses but also the reasoning behind any modifications or redirections, creating a foundation for continuous improvement of the system's operational guidelines.

The system may identify commonly useful queries that emerge from the broader user community. Rather than requiring each user to customize their entire interface, the system can suggest proven queries that have helped similar fleets improve their safety metrics. These suggestions may be contextual-for instance, offering weather-related queries during seasonal changes or sharing successful safety protocols from other fleets in the same geographic region.

The system tracks not just the queries themselves, but their effectiveness in driving safety improvements. When users interact with the natural language interface in ways that correlate with improved safety metrics, these interaction patterns may be analyzed and, where appropriate, suggested to other users facing similar challenges. This community learning approach helps fleet managers benefit from collective experience while maintaining individual fleet privacy and operational confidentiality.

Subsequent to generating the response, the system computes a query abstraction of the natural language query that preserves analytical intent while removing fleet-identifying information. Analytical intent comprises the underlying analytical objective of a query independent of specific entities or values, such as identifying drivers with elevated alert rates, comparing performance across time periods, or analyzing geographic patterns in incidents. The system extracts semantic features from the natural language query, wherein semantic features for abstraction purposes comprise query structure elements including question type, requested metrics, comparison operations, and temporal scope.

The system identifies named entities comprising driver names, vehicle identifiers, location names, and customer references, replaces identified named entities with categorical tokens indicating entity type without specific identity, and normalizes numerical values to categorical ranges. Categorical tokens comprise standardized placeholder identifiers indicating entity type while removing specific identity information. For example, a driver name such as “John Smith” is replaced with a categorical token such as “[DRIVER]” or “[DRIVER_1]” when multiple drivers are referenced in the same query. Vehicle identifiers such as “Truck 4472” are replaced with tokens such as “[VEHICLE]” or “[VEHICLE_ID].” Location names such as “Chicago distribution center” are replaced with categorical tokens indicating geographic granularity such as “[FACILITY],” “[CITY],” or “[REGION].” Customer references are replaced with tokens such as “[CUSTOMER]” or “[ACCOUNT].”

Categorical ranges comprise predefined value bands that replace specific numerical values while preserving analytical relevance. For example, a query referencing “47 drivers” may be normalized to a categorical range such as “[25-50_COUNT]” or a categorical descriptor such as “[MEDIUM_GROUP].” Fleet sizes may be normalized to categories such as “[SMALL_FLEET],” “[MEDIUM_FLEET],” or “[LARGE_FLEET].” Time periods may be normalized to categorical ranges such as “[PAST_WEEK],” “[PAST_MONTH],” or “[PAST_QUARTER].” Distance values may be normalized to operational categories such as “[LOCAL]” for distances under 100 miles, “[REGIONAL]” for distances between 100 and 500 miles, or “[LONG_HAUL]” for distances exceeding 500 miles. Alert counts may be normalized to severity bands such as “[LOW_FREQUENCY],” “[MODERATE_FREQUENCY],” or “[HIGH_FREQUENCY].” This abstraction preserves query structure and analytical intent while preventing identification of specific fleets or their operational details.

The system stores query abstractions in a community knowledge database aggregating abstracted query representations from a plurality of fleet management systems.

The system periodically analyzes the community knowledge database to identify high-value query patterns based on correlation between query patterns and fleet safety performance improvements. The system tracks safety performance metrics for fleets subsequent to query submission, wherein safety performance metrics comprise quantitative measures of fleet safety outcomes including collision rate reductions measured as percentage decrease in collisions per million miles, alert frequency changes measured as percentage change in alerts per driver per month, compliance score improvements measured as point increases in regulatory compliance indices, safety score increases measured on standardized scales, and trend indicators showing sustained improvement over multiple measurement periods.

The system computes correlation coefficients between query pattern occurrence and safety metric improvements, and classifies query patterns having correlation coefficients exceeding a correlation threshold as high-value query patterns. A correlation coefficient quantifies the statistical relationship between query pattern usage and subsequent safety improvements, with positive values indicating that fleets using a query pattern tend to show safety improvements. A correlation threshold defines a minimum correlation coefficient above which query patterns are classified as high-value. For example, a correlation threshold of 0.3 indicates moderate positive correlation sufficient for high-value classification, meaning that fleets using the query pattern show measurably better safety improvement trends than non-users. A threshold of 0.5 would require stronger correlation for classification. The correlation threshold may be adjusted based on statistical significance requirements, with higher thresholds appropriate when larger sample sizes enable detection of smaller effects, and lower thresholds appropriate when sample sizes are limited.

The system identifies source fleets having safety performance metrics in a top performance tier and applies elevated weighting to queries from top-tier fleets when computing correlation coefficients. A top performance tier comprises fleets ranking in an upper segment of the participating fleet population based on safety performance metrics. The top performance tier may be defined as fleets ranking in the top 10% or top 20% of safety scores across participating fleets, or alternatively as fleets exceeding an absolute performance threshold such as a safety score above 850 on a standardized 1000-point scale. Tier boundaries may be adjusted periodically based on overall population performance trends to maintain meaningful differentiation. Elevated weighting for top-tier fleets may comprise weighting multipliers such as 2.0 applied to query contributions from top-tier fleets compared to baseline weighting of 1.0 for other fleets. This weighting reflects the premise that analytical practices from high-performing fleets merit greater influence on pattern identification and correlation analysis.

The system generates best-practice query collections comprising high-value query patterns predominantly contributed by top-tier fleets and transmits suggested query templates derived from best-practice query collections to target fleet management systems based on contextual applicability criteria. Contextual applicability criteria comprise factors determining whether a query template is relevant for a particular target fleet, including operational category alignment such as distributing long-haul analysis templates to long-haul fleets rather than local delivery fleets, geographic relevance such as distributing winter weather safety templates to fleets operating in northern regions during winter months, current safety challenges such as offering following distance analysis templates to fleets experiencing elevated following distance alert rates, temporal relevance such as distributing holiday season preparation templates during peak shipping periods, and fleet maturity alignment such as distributing foundational analysis templates to fleets newly adopting the system and advanced optimization templates to experienced users. Contextual applicability may be computed as a weighted score across multiple criteria, with templates transmitted when the applicability score exceeds a distribution threshold.

The compliance and terminology guidance components operate prior to generating a response, ensuring that queries are assessed and potentially transformed before the core query processing occurs. The adaptive user interface generation and community learning components operate subsequent to generating a response, storing and analyzing query data without impacting response delivery to the user. This temporal separation enables modular deployment where pre-response and post-response components can be independently configured or updated. In certain configurations, the pre-response processing components operate as a standalone compliance layer applicable to various query processing architectures. In certain configurations, the post-response processing components operate independently of the specific query processing implementation, receiving query data from alternative fleet management systems. In certain configurations, the community learning components aggregate query abstractions from heterogeneous fleet management systems regardless of underlying query processing implementation.

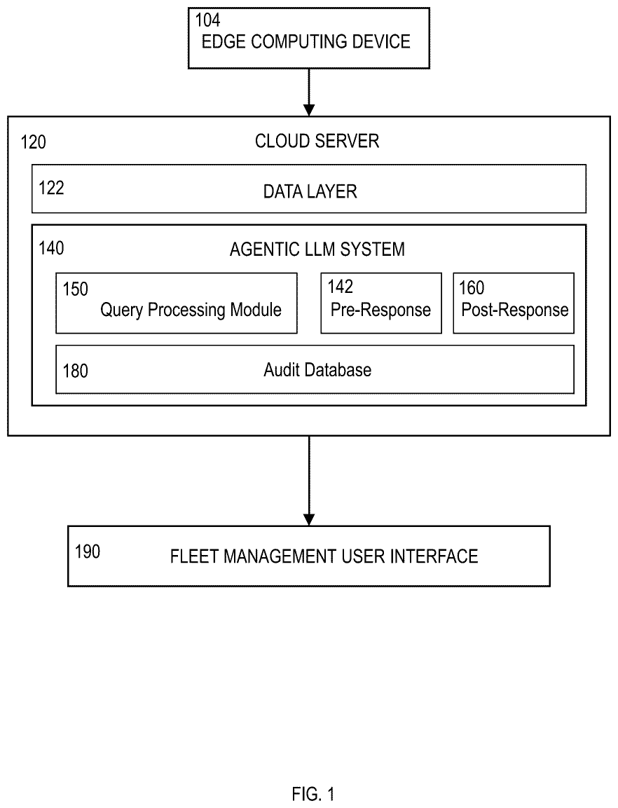

Referring now to FIG. 1, a system architecture for processing fleet safety queries is illustrated in accordance with certain aspects of the present disclosure. The system comprises an edge computing device 104 configured for installation in fleet vehicles, a cloud server 120 configured to receive and process data from fleet vehicles, and a fleet management user interface 190 configured to enable fleet safety managers to interact with the system.

The edge computing device 104 may be installed as an aftermarket component or integrated by a vehicle manufacturer as original equipment. In certain embodiments, the edge computing device 104 includes one or more cameras configured to capture video footage of driving events, a graphics processing unit configured to perform local inference operations on captured data, an inertial measurement unit configured to detect vehicle motion including acceleration, braking, and turning events, and storage configured to buffer data prior to transmission to the cloud server 120. The edge computing device 104 transmits captured data including video event records, telemetry data, and locally-generated alerts to the cloud server 120 via network connections.

The cloud server 120 includes a data layer 122 configured to store fleet safety data received from edge computing devices across a fleet. The data layer 122 may store data in a plurality of databases including a GPS tracking database, a vehicle telemetry database, a video event database, a driver performance database, and an alert database. In certain embodiments, the data layer 122 receives supplemental data from external sources including hours-of-service compliance systems, weather data providers, and traffic information services.

An agentic LLM system 140 resides within the cloud server 120 and processes natural language queries received from fleet management terminals. The agentic LLM system 140 includes a query processing module 150 configured to analyze incoming queries and generate responses, a pre-response module 142 configured to perform compliance analysis and terminology guidance prior to query processing, and a post-response module 160 configured to track query patterns and generate user interface improvements subsequent to response generation. An audit database 180 stores records of queries, compliance assessments, and responses for review and system improvement purposes.

The fleet management user interface 190 provides access to the agentic LLM system 140 for fleet safety managers. In certain embodiments, the fleet management user interface 190 comprises a web-based interface accessible via standard browsers, a mobile application, or a desktop application. The fleet management user interface 190 receives natural language queries from users and displays responses generated by the agentic LLM system 140.

In certain embodiments, the system architecture supports integration with vehicle original equipment manufacturer systems that provide additional vehicle operational data through standardized interfaces such as OBD-II or CAN bus connections. The system architecture also supports extensible integration with third-party data sources without requiring architectural modifications to the core processing components.

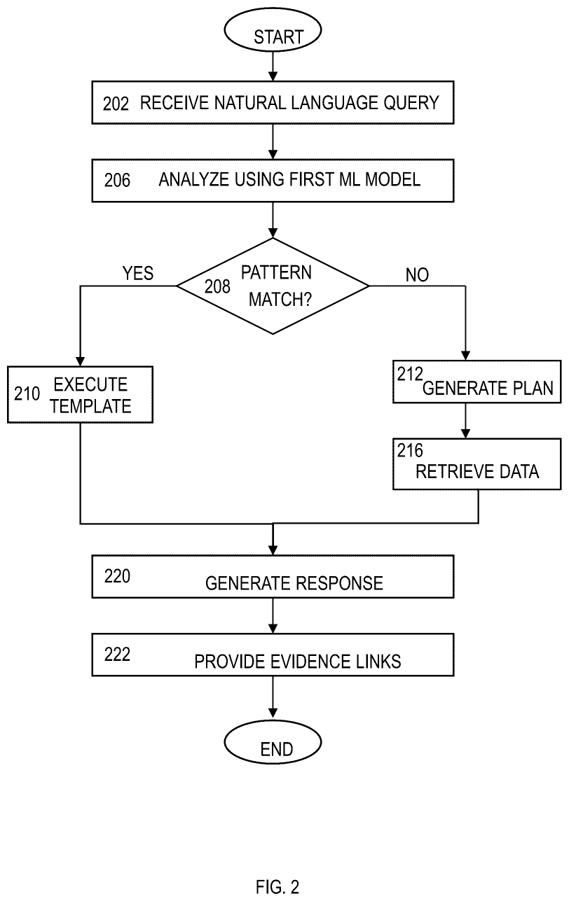

Referring now to FIG. 2, a method for processing fleet safety queries is illustrated as a flowchart in accordance with certain aspects of the present disclosure. The method begins at a start state and proceeds through a series of processing steps.

At step 202, the cloud server 120 receives a natural language query regarding fleet safety data. The natural language query may be received from the fleet management user interface 190 and may comprise questions, commands, or requests for analysis relating to fleet operations, driver performance, vehicle status, safety incidents, or compliance matters. Examples of natural language queries include requests to identify drivers exhibiting particular behaviors, requests to analyze patterns across multiple data dimensions, and requests to generate reports summarizing fleet performance metrics.

At step 206, the system analyzes the natural language query using a first machine learning model to determine whether the query matches any predetermined query patterns. The first machine learning model may comprise a transformer-based encoder configured to generate vector representations of incoming queries and compare these representations against stored patterns from previously processed queries.

At decision step 208, the system determines whether a pattern match exists. The determination may be based on a similarity metric computed between the vector representation of the incoming query and stored query vectors, with a match indicated when the similarity metric exceeds a configurable similarity threshold.

Upon determining that a pattern match exists, the method proceeds to step 210 where the system executes a stored template associated with the matched pattern. The stored template specifies data retrieval operations, processing steps, and response formatting previously validated for the matched query type. Execution of stored templates enables efficient processing of recurring query types without requiring full plan generation.

Upon determining that no pattern match exists at decision step 208, the method proceeds to step 212 where the system generates a proposed data retrieval plan using a second machine learning model. The second machine learning model may comprise a decoder configured to generate structured retrieval plans based on the semantic content of the natural language query. The proposed data retrieval plan specifies target database tables, query parameters, join conditions linking disparate data sources, and temporal filters.

At step 216, the system retrieves data from identified sources according to the proposed data retrieval plan. Data retrieval may involve executing queries against multiple databases within the data layer 122, correlating records based on temporal proximity and vehicle identifiers, and integrating retrieved data into a unified result set.

At step 220, the system generates a response including the retrieved data. Response generation may involve formatting retrieved data according to the query context, generating natural language explanations of findings, and organizing results for presentation through the fleet management user interface 190.

At step 222, the system provides supporting evidence links associated with factual assertions in the response. Each factual assertion in the generated response is associated with references to underlying source records, enabling fleet safety managers to verify response accuracy against primary data sources. The method then proceeds to an end state.

In certain embodiments, the method includes additional processing phases before and after the core query processing steps. A pre-response phase may analyze the natural language query for compliance with operational guidelines and provide terminology guidance. A post-response phase may track query patterns for user interface development and contribute query abstractions to community knowledge systems. These additional phases are described in connection with subsequent figures.

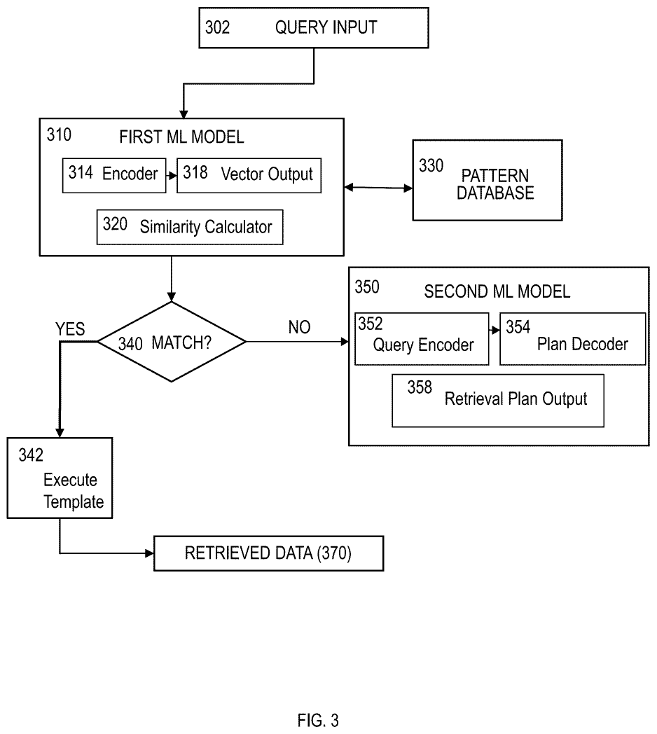

Referring now to FIG. 3, a detailed view of the query processing module 150 is illustrated in accordance with certain aspects of the present disclosure. FIG. 3 shows the two-model architecture employed for processing natural language queries.

A query input 302 receives the natural language query from the fleet management user interface 190. The query input 302 may perform initial preprocessing including tokenization, normalization, and extraction of query metadata.

A first machine learning model 310 analyzes the query input 302 to determine pattern matches. The first machine learning model 310 includes an encoder 314 configured to transform the natural language query into a vector representation. The encoder 314 may comprise a transformer-based architecture that encodes semantic features of the query into a multi-dimensional embedding space. A vector output 318 represents the encoded query as a numerical vector suitable for similarity computations.

A similarity calculator 320 compares the vector output 318 against stored vectors in a pattern database 330. The pattern database 330 stores vector representations of previously processed queries along with associated retrieval plans and response templates. The similarity calculator 320 computes a similarity metric between the vector output 318 and each stored query vector using distance measures such as cosine similarity or Euclidean distance.

At decision point 340, the system determines whether a match exists based on the computed similarity metrics. A match may be indicated when the highest similarity metric exceeds a configurable similarity threshold.

Upon determining that a match exists, the method proceeds to step 342 where the system executes the template associated with the matched pattern. Template execution retrieves the stored retrieval plan and response format, enabling efficient processing without full plan generation.

Upon determining that no match exists at decision point 340, the method proceeds to a second machine learning model 350. The second machine learning model 350 generates a proposed data retrieval plan for the unmatched query. A query encoder 352 processes the natural language query to extract semantic features relevant to plan generation. A plan decoder 354 generates a structured data retrieval plan based on the extracted features. A retrieval plan output 358 specifies the generated plan including target databases, query parameters, join conditions, and temporal filters.

Retrieved data 370 represents the data obtained by executing the retrieval plan against the data layer 122. The retrieved data 370 is processed to generate a response for the user.

In certain embodiments, the query processing module 150 stores newly generated retrieval plans in the pattern database 330 for subsequent pattern matching operations. Storage may include extracting analysis parameters from the natural language query, recording metadata identifying accessed data sources, and associating verification requirements based on data sensitivity classifications. This learning mechanism enables the system to improve processing efficiency over time as more query patterns are encountered and stored.

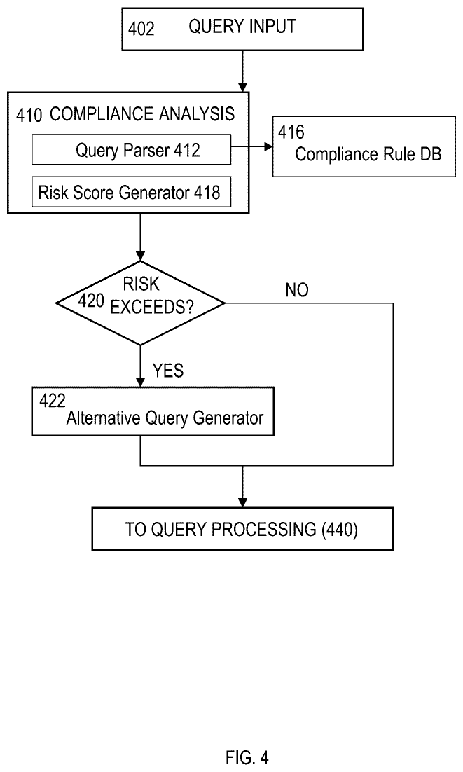

Referring now to FIG. 4, a pre-response processing method is illustrated in accordance with certain aspects of the present disclosure. The pre-response processing analyzes natural language queries prior to core query processing to ensure compliance with operational guidelines and provide terminology guidance.

A query input 402 receives the natural language query prior to processing by the query processing module 150. The pre-response processing may operate as a preprocessing layer that analyzes queries before they reach the core query processing components.

A compliance analysis module 410 determines whether the requested analysis complies with predetermined operational guidelines. The compliance analysis module 410 includes a query parser 412 configured to parse the natural language query and identify requested analysis parameters comprising target data fields, aggregation dimensions, and filter criteria.

A compliance rule database 416 stores prohibited analysis patterns and operational guidelines. The compliance rule database 416 may include rules addressing data privacy requirements, employment law compliance requirements, and organizational policies regarding appropriate data usage. In certain embodiments, the compliance rule database 416 stores rules that identify potentially discriminatory analysis patterns and redirect such analyses toward objective safety metrics and behavioral patterns.

A risk score generator 418 compares the requested analysis parameters against the compliance rule database 416 and generates a compliance risk score based on matching between requested parameters and prohibited patterns. The compliance risk score quantifies the degree to which a requested analysis may conflict with operational guidelines. The risk score may be computed as a weighted sum of individual pattern matches, wherein each prohibited pattern has an associated severity weight reflecting regulatory risk. For example, a pattern matching employment discrimination concerns may carry higher weight than a pattern matching documentation style preferences. The computed risk score may be normalized to a scale of 0.0 to 1.0 for comparison against the compliance threshold.

At decision point 420, the system determines whether the compliance risk score exceeds a compliance threshold. The compliance threshold may be configured based on organizational risk tolerance and regulatory requirements.

Upon determining that the compliance risk score does not exceed the threshold, the query proceeds to query processing at output 440 without modification.

Upon determining that the compliance risk score exceeds the threshold, the method proceeds to step 422 where an alternative query generator produces a modified query. The alternative query generator creates a query that achieves the safety-related analytical objectives of the original query while avoiding prohibited analysis patterns. The alternative query is then processed in place of the original natural language query.

In certain embodiments, the pre-response processing includes a terminology guidance component. The terminology guidance component analyzes terminology used in the natural language query against a terminology guidance database storing term pairs comprising disfavored terms and preferred alternative terms. Upon detecting presence of disfavored terms, the system generates a terminology suggestion comprising the preferred alternative term and an explanatory rationale. For example, the terminology guidance database may store a first term pair mapping a collision-related disfavored term to a preferred neutral term, and a second term pair mapping a driver qualification disfavored term to a preferred standard-of-care-neutral term. These terminology suggestions help fleet safety managers maintain documentation practices that align with industry standards and reduce potential liability exposure.

The pre-response processing logs queries, compliance assessments, and any modifications in the audit database 180 for review and compliance monitoring purposes.

In certain embodiments, the pre-response processing may operate independently of the specific query processing implementation described herein. The compliance analysis and terminology guidance components may be implemented as standalone preprocessing layers applicable to various query processing architectures, enabling integration with third-party fleet management systems or alternative query processing implementations.

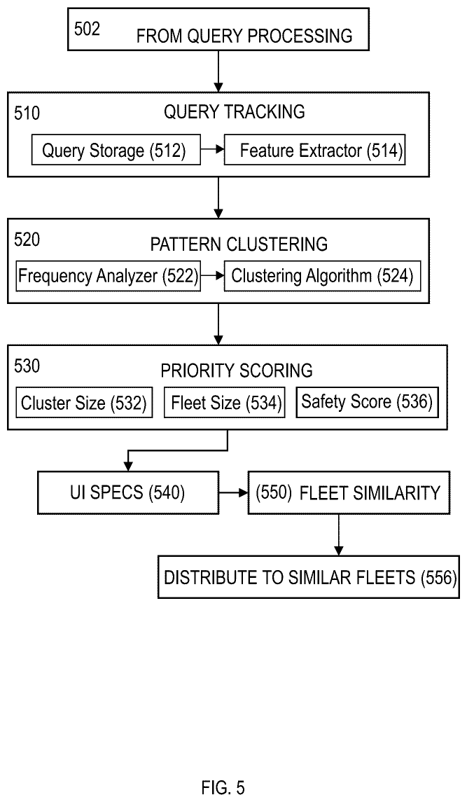

Referring now to FIG. 5, a post-response processing method for user interface generation is illustrated in accordance with certain aspects of the present disclosure. The post-response processing analyzes query patterns subsequent to response generation to identify opportunities for user interface improvements.

An input 502 receives query data from the query processing module 150 subsequent to generating a response. The post-response processing operates asynchronously from the query-response cycle, enabling analysis without impacting response latency.

A query tracking module 510 stores and processes query data for pattern analysis. The query tracking module 510 includes a query storage component 512 configured to store natural language queries in a query tracking database associated with a fleet identifier of the originating fleet management terminal. A feature extractor 514 extracts characteristics from stored queries including query type, referenced data fields, temporal scope, and aggregation patterns.

A pattern clustering module 520 identifies recurring query patterns across the stored query population. A frequency analyzer 522 tracks the frequency of query patterns across a plurality of fleet management terminals, counting occurrences of similar queries over configurable time periods such as weekly or monthly intervals. A clustering algorithm 524 groups similar queries based on extracted features, identifying query patterns that exceed a predetermined frequency threshold. The predetermined frequency threshold may be set based on system query volume, such as 50 occurrences per month for systems processing thousands of queries, or 10 occurrences per month for smaller deployments. The clustering algorithm 524 may employ techniques such as k-means clustering, hierarchical clustering, or density-based clustering to identify meaningful query groupings based on feature similarity.

A priority scoring module 530 computes priority scores for identified query pattern clusters to determine which patterns warrant user interface development. The priority scoring module 530 considers multiple factors including cluster size 532 representing the number of queries in each cluster, fleet size 534 representing the aggregate size of fleets contributing queries to each cluster, and safety score 536 representing the aggregate safety performance scores of contributing fleets.

In certain embodiments, the priority scoring module 530 retrieves, for each fleet contributing queries to a query pattern cluster, a computed safety score derived from collision rates, alert frequencies, and compliance metrics. The system applies elevated weighting to query contributions from fleets having safety scores exceeding a performance threshold. This weighting mechanism enables the system to learn from high-performing fleets, as queries from fleets with strong safety records may indicate effective analytical practices worthy of broader deployment.

A user interface specifications output 540 represents generated specifications for user interface components based on prioritized query patterns. The specifications may define dashboard widgets, report templates, or interactive analysis tools that address frequently requested analytical needs.

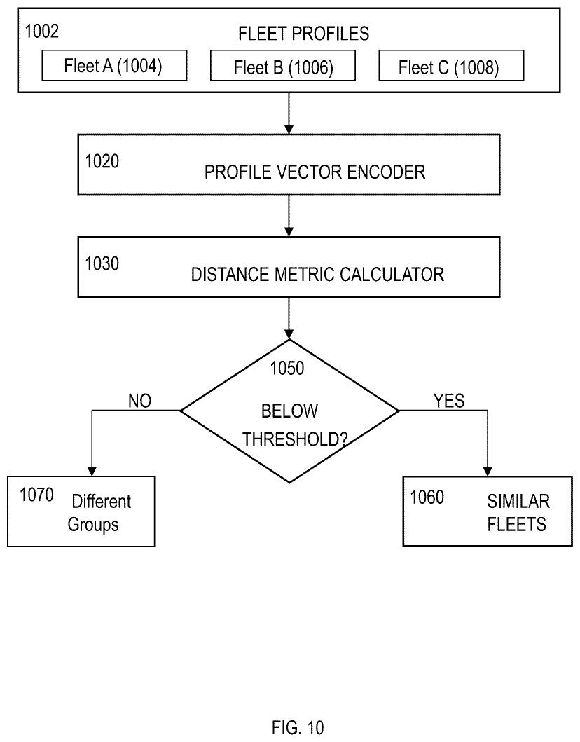

A fleet similarity module 550 determines similarity between fleets to enable targeted distribution of generated user interface components. The fleet similarity module 550 operates in conjunction with the fleet similarity determination process described in connection with FIG. 10.

A distribution output 556 transmits generated user interface component specifications to fleet management terminals associated with similar fleets. Distribution may be limited to fleets within the same industry vertical, geographic region, or operational category to ensure relevance of deployed components.

In certain embodiments, the post-response processing for user interface generation may operate independently of the specific query processing implementation described herein. The query tracking, pattern clustering, priority scoring, and distribution components may receive query data from alternative sources including third-party fleet management systems, enabling user interface improvements across heterogeneous fleet management platforms.

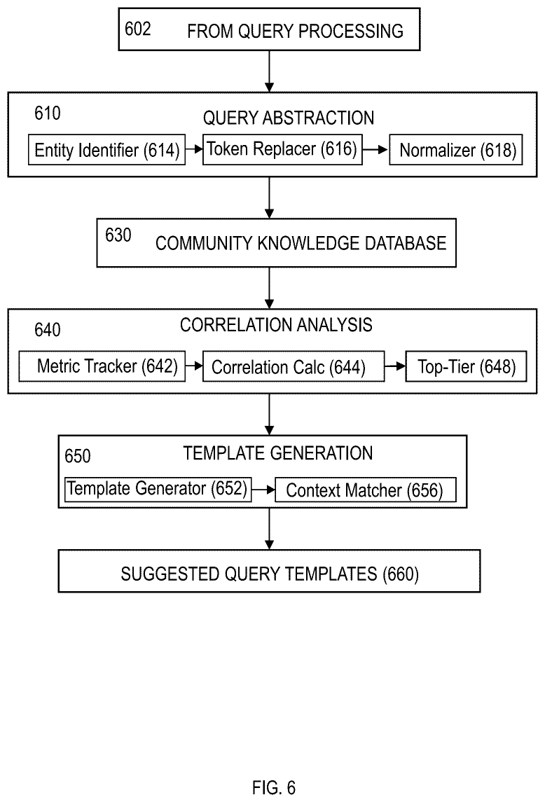

Referring now to FIG. 6, a post-response processing method for community learning is illustrated in accordance with certain aspects of the present disclosure. The community learning process enables privacy-preserving knowledge sharing across fleet management systems.

An input 602 receives query data from the query processing module 150 subsequent to generating a response. The community learning process operates asynchronously and independently from individual query-response cycles.

A query abstraction module 610 computes abstractions of natural language queries that preserve analytical intent while removing fleet-identifying information. The query abstraction module 610 includes an entity identifier 614 configured to identify named entities in the natural language query comprising driver names, vehicle identifiers, location names, and customer references. A token replacer 616 replaces identified named entities with categorical tokens indicating entity type without specific identity. For example, a specific driver name may be replaced with a driver category token, and a specific location may be replaced with a geographic region token. A normalizer 618 normalizes numerical values referenced in the natural language query to categorical ranges, preventing identification of specific fleets through distinctive numerical patterns.

A community knowledge database 630 aggregates abstracted query representations from a plurality of fleet management systems. The community knowledge database 630 stores query abstractions along with metadata indicating query context, submission timing, and anonymized fleet characteristics.

A correlation analysis module 640 identifies relationships between query patterns and fleet safety performance improvements. A metric tracker 642 tracks safety performance metrics for fleets subsequent to query submission, measuring changes in safety indicators over configurable observation periods such as 30, 60, or 90 days following query usage. The tracked metrics may include collision rates expressed as incidents per million miles, alert frequencies expressed as alerts per driver per month, compliance scores expressed as percentage adherence to operational policies, and composite safety scores combining multiple indicators. A correlation calculator 644 computes correlation coefficients between query pattern occurrence and safety metric improvements using statistical methods such as Pearson correlation or Spearman rank correlation. Query patterns having correlation coefficients exceeding a correlation threshold, such as a coefficient of 0.3 or higher indicating moderate positive correlation, are classified as high-value query patterns indicating analytical approaches associated with improved safety outcomes.

A top-tier identifier 648 identifies source fleets having safety performance metrics in a top performance tier. The system applies elevated weighting to queries from top-tier fleets when computing correlation coefficients, enabling the system to learn from fleets demonstrating best practices in safety management.

A template generation module 650 generates query templates based on identified high-value query patterns. A template generator 652 creates reusable query templates that capture the analytical approach embodied in high-value patterns. A context matcher 656 determines contextual applicability criteria for generated templates, identifying fleet characteristics and situations where each template may provide value.

A suggested query templates output 660 represents templates available for distribution to target fleet management systems. Templates may be transmitted based on contextual applicability criteria including fleet operational characteristics, current safety challenges, and seasonal or geographic factors.

In certain embodiments, the community learning process generates best-practice query collections comprising high-value query patterns predominantly contributed by top-tier fleets. These collections represent analytical approaches associated with superior safety outcomes and may be distributed to fleets seeking to improve their safety practices.

In certain embodiments, the community learning system may operate independently of the specific query processing implementation described herein. The query abstraction, correlation analysis, and template generation components may aggregate query abstractions from heterogeneous fleet management systems regardless of underlying query processing implementation, enabling cross-platform knowledge sharing while maintaining fleet privacy.

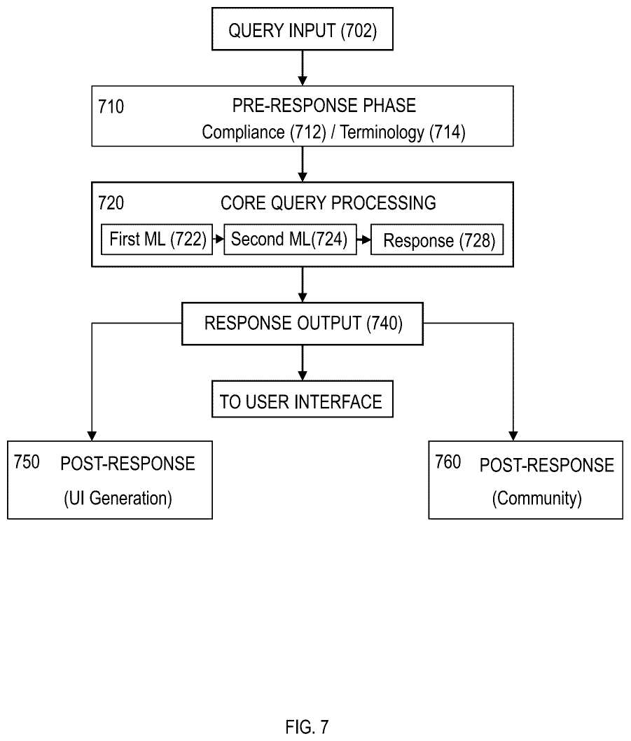

Referring now to FIG. 7, an integrated view of the query processing flow is illustrated in accordance with certain aspects of the present disclosure. FIG. 7 shows the temporal relationship between pre-response processing, core query processing, and post-response processing phases.

A query input 702 represents a natural language query received from the fleet management user interface 190. The query input 702 initiates the processing flow.

A pre-response phase 710 processes the query prior to core query processing. The pre-response phase 710 includes compliance processing 712 as described in connection with FIG. 4, and terminology guidance processing 714. The pre-response phase 710 may modify the query, generate suggestions for the user, or allow the query to proceed unchanged based on compliance analysis results.

A core query processing phase 720 processes the query using the two-model architecture. The core query processing phase 720 includes first machine learning model processing 722 for pattern matching, second machine learning model processing 724 for plan generation when no pattern match exists, and response generation 728 based on retrieved data.

A response output 740 represents the generated response transmitted to the user interface. The response output 740 includes the response content along with supporting evidence links associated with factual assertions.

A first post-response phase 750 performs user interface generation processing subsequent to response generation. The first post-response phase 750 corresponds to the processing described in connection with FIG. 5, including query tracking, pattern clustering, priority scoring, and user interface component distribution.

A second post-response phase 760 performs community learning processing subsequent to response generation. The second post-response phase 760 corresponds to the processing described in connection with FIG. 6, including query abstraction, correlation analysis, and template generation.

In certain embodiments, the pre-response and post-response phases operate independently from the core query processing phase. Each phase may be enabled, disabled, or configured independently based on organizational requirements and system deployment configuration. This modular architecture enables flexible deployment scenarios where individual processing phases may be implemented separately or integrated with alternative query processing systems.

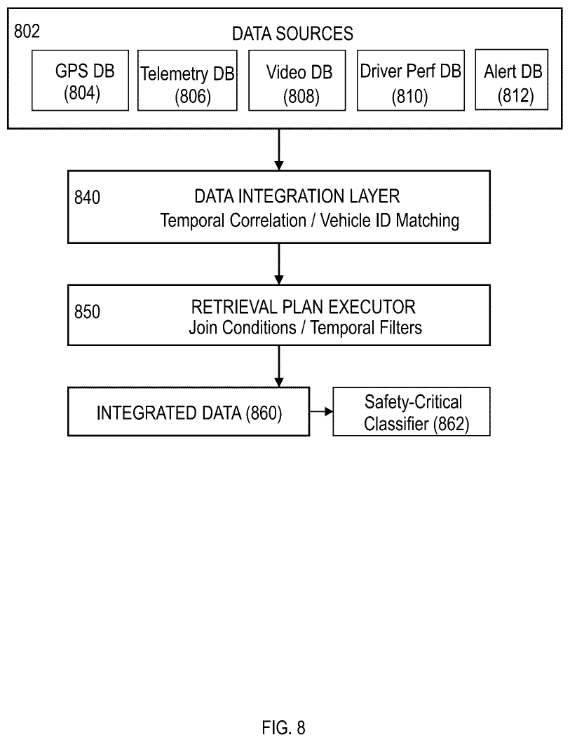

Referring now to FIG. 8, a data sources and integration architecture is illustrated in accordance with certain aspects of the present disclosure. FIG. 8 shows the plurality of data sources available for query processing and the integration mechanisms for correlating data across sources.

A data sources layer 802 represents the plurality of databases storing fleet safety data. The data sources layer 802 includes a GPS database 804 storing vehicle location records including position coordinates, timestamps, speed values, and heading information. A telemetry database 806 stores vehicle operational data including engine parameters, fuel consumption metrics, and diagnostic fault codes. A video database 808 stores video event records captured by edge computing devices, including footage of driving events, incidents, and safety-relevant situations. A driver performance database 810 stores computed metrics characterizing individual driver behavior including safety scores, compliance rates, and trend indicators. An alert database 812 stores records of detected events including hard braking instances, following distance violations, traffic signal violations, and other safety-relevant occurrences.

In certain embodiments, the data sources layer 802 includes additional databases storing supplemental information. These may include hours-of-service compliance databases receiving data from electronic logging devices, weather databases providing environmental conditions along fleet routes, traffic databases providing congestion and incident information, and maintenance databases tracking vehicle service history and scheduled maintenance requirements.

A data integration layer 840 correlates data from multiple sources to fulfill complex queries. The data integration layer 840 performs temporal correlation to align records from different sources based on timestamp proximity within configurable temporal windows. The data integration layer 840 also performs vehicle identifier matching to associate records from different sources pertaining to the same vehicle or driver.

A retrieval plan executor 850 executes structured retrieval plans generated by the second machine learning model. The retrieval plan executor 850 interprets join conditions specified in retrieval plans to combine data from multiple sources. The retrieval plan executor 850 also applies temporal filters to limit retrieved data to specified time ranges.

An integrated data output 860 represents the combined result of multi-source data retrieval. The integrated data output 860 may include records from multiple databases correlated by vehicle, driver, time, or other linking attributes.

A safety-related classifier 862 identifies data elements requiring additional verification or handling. Safety-related data elements may include collision event records, driver alert violations exceeding a severity threshold, hours-of-service compliance deviations, or vehicle maintenance fault codes. When safety-related data elements are identified, the system may execute verification operations against primary data sources to confirm accuracy before including the elements in generated responses.

In certain embodiments, the data integration layer 840 generates data consistency scores when integrating data from multiple sources. The data consistency scores quantify the degree of agreement between overlapping data fields from different sources, enabling identification of potential data quality issues. For example, when integrating GPS data with telemetry data, the system may compare vehicle speed values from both sources and compute a consistency score based on the percentage of records where speed values agree within a tolerance threshold such as plus or minus 5 miles per hour. Consistency scores may be computed separately for different field types and aggregated into an overall integration quality indicator. Low consistency scores may trigger data quality alerts or cause affected data elements to be flagged with uncertainty indicators in generated responses.

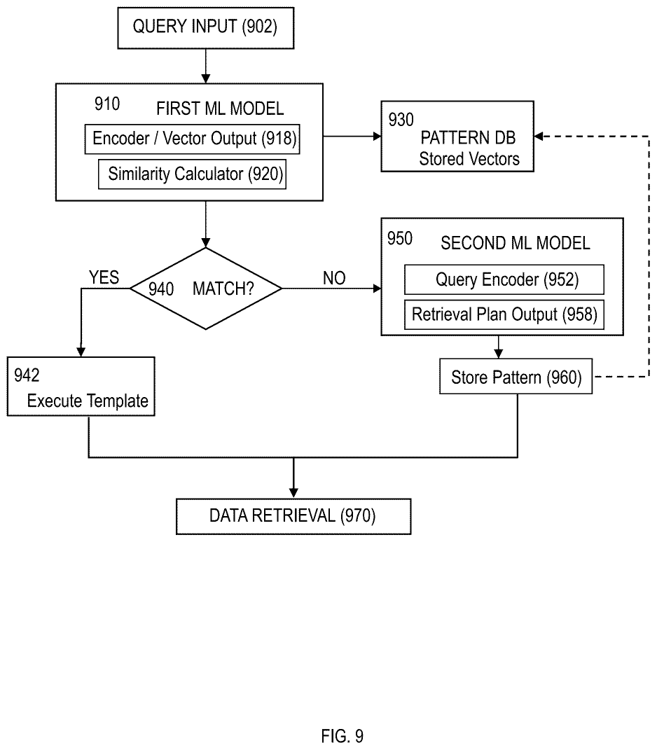

Referring now to FIG. 9, a detailed view of the two-model query architecture is illustrated in accordance with certain aspects of the present disclosure. FIG. 9 provides additional detail regarding the interaction between the first and second machine learning models during query processing.

A query input 902 receives the natural language query for processing. The query input 902 provides the query to the first machine learning model for pattern matching analysis.

A first machine learning model 910 analyzes the query to determine pattern matches. The first machine learning model 910 includes an encoder that transforms the natural language query into a vector representation. The encoder may comprise transformer layers that process query tokens and generate contextual embeddings capturing semantic relationships between query terms.

A vector output 918 represents the encoded query as a multi-dimensional embedding suitable for similarity computations. The vector output 918 captures the semantic content and analytical intent of the natural language query in a numerical form enabling efficient comparison operations.

A similarity calculator 920 compares the vector output 918 against stored vectors in a pattern database 930. The pattern database 930 stores vector representations of previously processed queries along with associated retrieval plans, response templates, and execution metadata. The similarity calculator 920 computes distance metrics between the query vector and each stored vector to identify potential matches.

At decision point 940, the system determines whether a match exists based on computed similarity metrics. A match is indicated when a similarity metric exceeds a configurable threshold, indicating that a stored pattern sufficiently corresponds to the incoming query.

Upon determining that a match exists, the method proceeds to step 942 where the system executes the template associated with the matched pattern. Template execution bypasses plan generation by retrieving and executing a validated retrieval plan, enabling efficient processing of recurring query types.

Upon determining that no match exists at decision point 940, the method proceeds to a second machine learning model 950. The second machine learning model 950 generates a retrieval plan for queries lacking pattern matches. A query encoder 952 processes the natural language query to extract features relevant to plan generation including entity references, temporal expressions, aggregation indicators, and filtering criteria.

A retrieval plan output 958 specifies the generated plan including target database tables, query parameters, join conditions for linking disparate data sources, and temporal filters for limiting result scope.

At step 960, the system stores the generated pattern for subsequent matching operations. Pattern storage includes extracting analysis parameters from the natural language query, recording metadata identifying accessed data sources, documenting data integration steps, recording verification requirements, and storing successful response templates. This learning mechanism enables the system to improve processing efficiency as more query patterns are encountered.

A data retrieval step 970 executes the retrieval plan against the data sources to obtain data for response generation.

Referring now to FIG. 10, a fleet similarity determination process is illustrated in accordance with certain aspects of the present disclosure. The fleet similarity determination enables targeted distribution of user interface components and query templates to fleets sharing relevant operational characteristics.

A fleet profiles section 1002 represents profile data for multiple fleets participating in the system. Fleet A profile 1004, Fleet B profile 1006, and Fleet C profile 1008 represent individual fleet profiles containing operational characteristics. Fleet profiles may include attributes such as fleet size category, operational category indicating the type of transportation services provided, primary geographic region of operations, and cargo type classification.

In certain embodiments, operational categories include distinctions relevant to fleet safety analysis such as long-haul versus regional operations, truckload versus less-than-truckload operations, and specialized cargo types including hazardous materials, refrigerated goods, or passenger transport. Geographic region attributes may capture climate considerations affecting safety practices, regulatory jurisdictions affecting compliance requirements, and terrain characteristics affecting driving conditions.

A profile vector encoder 1020 represents each fleet profile as a numerical vector encoding the fleet's operational characteristics. The profile vector encoder 1020 transforms categorical and numerical profile attributes into a multi-dimensional vector representation suitable for distance computations. Encoding may employ techniques such as one-hot encoding for categorical attributes, normalization for numerical attributes, and embedding layers for high-cardinality categorical attributes.

A distance metric calculator 1030 computes distance metrics between fleet profile vectors. The distance metric calculator 1030 may employ distance measures such as Euclidean distance, cosine distance, or weighted distance measures that emphasize operationally significant attributes. Lower distance values indicate greater similarity between fleet profiles.

At decision point 1050, the system determines whether computed distance metrics fall below a similarity threshold. The similarity threshold may be configured based on desired granularity of fleet groupings and the specific application requiring similarity determination.

Upon determining that distance metrics fall below the threshold, the system identifies fleets as belonging to a similar fleet group 1060. Fleets within similar groups may receive shared user interface components, suggested query templates, and other resources developed based on collective query patterns.

Upon determining that distance metrics exceed the threshold, the system identifies fleets as belonging to different groups. Fleets in different groups receive separately developed resources tailored to their distinct operational characteristics.

In certain embodiments, the fleet similarity determination supports multiple similarity groupings based on different attribute subsets. For example, fleets may be grouped by operational category for query template distribution while being grouped by geographic region for weather-related resource distribution. This flexible grouping enables context-appropriate resource sharing across multiple dimensions of fleet similarity.

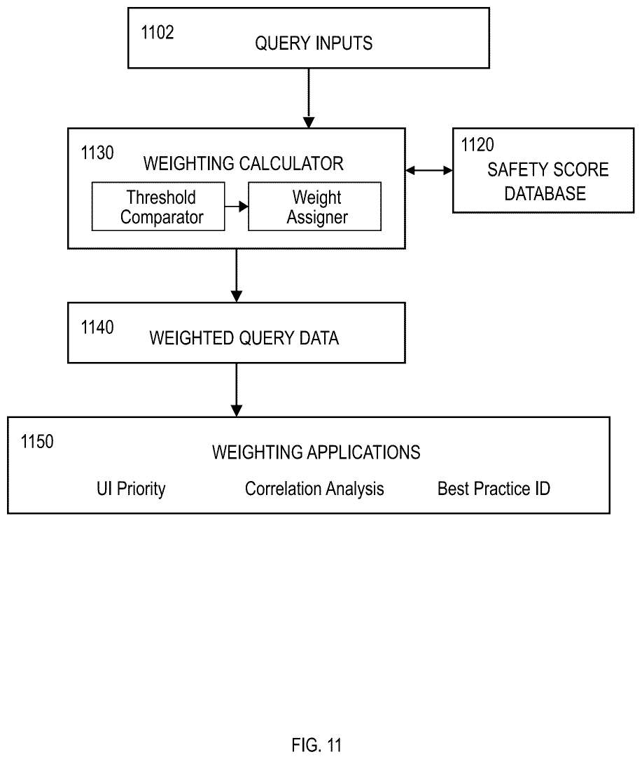

Referring now to FIG. 11, a safety score weighting system is illustrated in accordance with certain aspects of the present disclosure. The safety score weighting system enables preferential treatment of query patterns from high-performing fleets when analyzing community-wide query data.

A query inputs section 1102 represents queries received from multiple fleets participating in the system. Queries from different fleets are aggregated for pattern analysis and correlation computations.

A safety score database 1120 stores computed safety scores for participating fleets. Safety scores may be derived from multiple performance indicators including collision rates, alert frequencies, compliance metrics, and trend indicators showing improvement or decline over time. In certain embodiments, the safety score database 1120 stores scores computed according to standardized methodologies enabling comparison across fleets of different sizes and operational categories.

A weighting calculator 1130 applies differential weighting to query contributions based on fleet safety performance. The weighting calculator 1130 includes a threshold comparator that evaluates each contributing fleet's safety score against configurable performance thresholds. Multiple threshold levels may be defined to create performance tiers such as baseline, above-average, and top-tier categories.

A weight assigner within the weighting calculator 1130 assigns weighting multipliers based on threshold comparison results. Fleets with safety scores exceeding higher thresholds receive elevated weighting multipliers, causing their query patterns to have greater influence on pattern analysis and correlation computations. Multiple performance tiers may be defined with corresponding multipliers. For example, a fleet in a top performance tier, such as the top 10% by safety score, may receive a weighting multiplier of 2.0; a fleet in an above-average tier, such as the 75th to 90th percentile, may receive a weighting multiplier of 1.5; and a fleet in the baseline tier, below the 75th percentile, receives a weighting multiplier of 1.0. The multipliers may be configured by system administrators based on desired influence distribution and may be adjusted over time based on observed correlation between tier membership and query pattern value.

A weighted query data output 1140 represents the query data with applied weighting factors. The weighted query data flows to downstream analysis processes with contributions from high-performing fleets amplified according to their assigned weights.

A weighting applications section 1150 illustrates applications of the weighted query data. User interface priority scoring uses weighted data to prioritize development of interface components addressing query patterns emphasized by high-performing fleets. Correlation analysis uses weighted data when computing correlations between query patterns and safety improvements, enabling identification of analytical practices associated with superior outcomes. Best practice identification uses weighted data to identify query patterns predominantly employed by top-tier fleets, enabling extraction of effective analytical approaches for broader distribution.

In certain embodiments, the safety score weighting system considers additional weighting factors beyond safety performance scores. These may include advisory board membership status for fleets whose representatives participate in industry guidance activities such as customer advisory boards or industry working groups, wherein such fleets may receive elevated weighting such as a 1.25× multiplier reflecting their role as industry thought leaders. Feature adoption metrics indicating depth of engagement with fleet management capabilities may serve as weighting factors, wherein fleets utilizing advanced features such as in-cab alerts, driver coaching applications, gamification programs, or multi-camera configurations may receive elevated weighting based on the premise that engaged users generate more informed queries. Demonstrated improvement trends showing sustained commitment to safety enhancement may provide weighting adjustments, wherein fleets showing consistent month-over-month safety score improvements over periods such as six consecutive months may receive elevated weighting reflecting proven commitment to safety-focused operations.

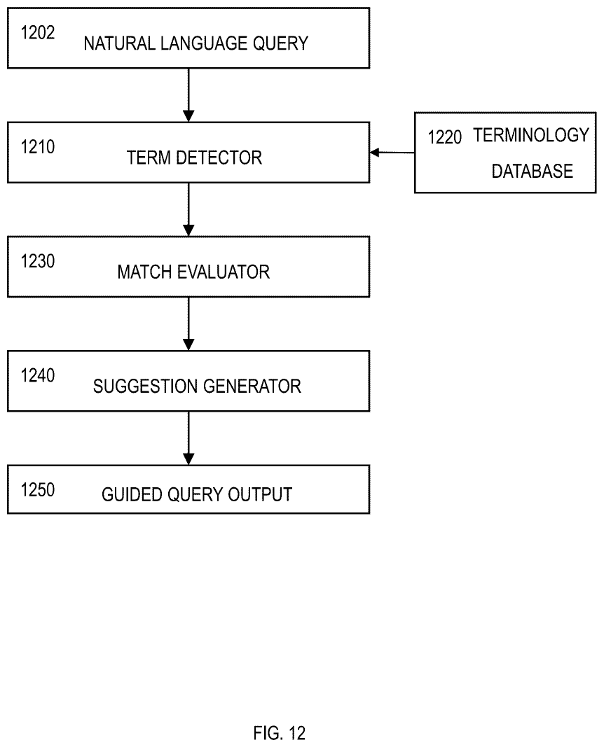

Referring now to FIG. 12, a terminology guidance system is illustrated in accordance with certain aspects of the present disclosure. The terminology guidance system helps fleet safety managers maintain documentation practices aligned with industry standards and legal considerations.

A natural language query input 1202 receives a query for terminology analysis. The terminology analysis may be performed as part of pre-response processing prior to core query processing.

A term detector 1210 analyzes the natural language query to identify terms that may warrant guidance. The term detector 1210 may employ natural language processing techniques including tokenization, part-of-speech tagging, and named entity recognition to identify relevant terms within the query text.

A terminology database 1220 stores term pairs comprising disfavored terms and preferred alternative terms. Each term pair associates a term that may create documentation issues with a preferred alternative that conveys equivalent meaning while reducing potential complications. The terminology database 1220 may be organized by category including collision-related terminology, personnel-related terminology, severity-related terminology, and fault-related terminology.

In certain embodiments, the terminology database 1220 stores term pairs addressing specific documentation concerns. A first term pair may map a collision-related disfavored term to a preferred neutral term, based on the consideration that certain terminology may carry connotations affecting perception in legal or regulatory contexts. A second term pair may map a driver qualification disfavored term to a preferred standard-of-care-neutral term, based on the consideration that qualification-related terminology may affect liability assessments.

A match evaluator 1230 compares detected terms against entries in the terminology database 1220. The match evaluator 1230 may employ fuzzy matching techniques to identify terms similar to database entries, accommodating variations in spelling, tense, and word form. Upon detecting a match, the match evaluator 1230 retrieves the associated preferred term and guidance information.

A suggestion generator 1240 generates terminology suggestions for presentation to the user. Each suggestion includes the preferred alternative term and an explanatory rationale describing the basis for the recommendation. The explanatory rationale may reference documentation best practices, industry standards, or specific considerations motivating the guidance. Suggestions are presented in a manner that informs without requiring acceptance, enabling users to make informed decisions about terminology choices.

A guided query output 1250 represents the query after terminology analysis, along with any generated suggestions. The guided query output 1250 proceeds to core query processing while suggestions are presented to the user through the fleet management user interface 190.

In certain embodiments, the terminology guidance system maintains logs of terminology suggestions and user responses for system improvement purposes. Analysis of suggestion acceptance rates may inform refinement of the terminology database 1220 and suggestion presentation approaches.

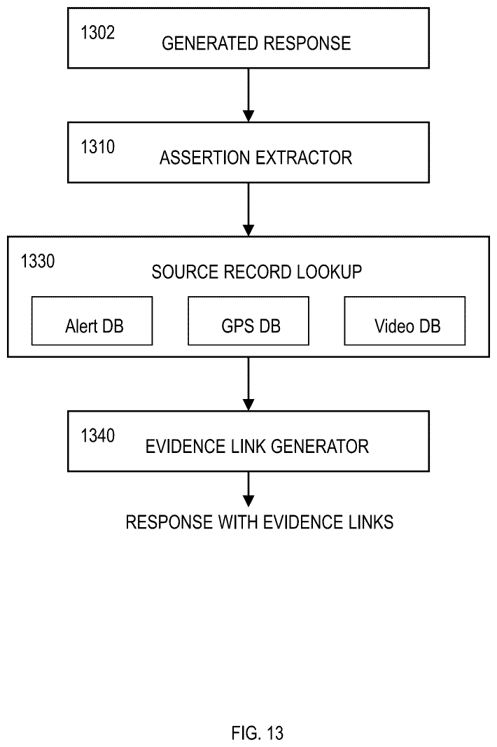

Referring now to FIG. 13, an evidence link generation process is illustrated in accordance with certain aspects of the present disclosure. The evidence link generation enables verification of factual assertions in generated responses by associating assertions with references to underlying source records.

A generated response input 1302 receives a response generated by the query processing module 150. The generated response may include factual assertions derived from retrieved fleet safety data.

An assertion extractor 1310 identifies factual assertions within the generated response. Factual assertions may include numerical values, event counts, date references, status indicators, and other verifiable statements. The assertion extractor 1310 may employ natural language processing techniques to distinguish factual assertions from explanatory text, recommendations, and other non-verifiable content.

A source record lookup module 1330 identifies source records supporting each extracted assertion. The source record lookup module 1330 queries relevant databases within the data layer 122 to locate records corresponding to assertions. The source record lookup module 1330 may query an alert database to locate records supporting alert-related assertions, a GPS database to locate records supporting location-related assertions, and a video database to locate records supporting event-related assertions with video evidence. Additional data sources may be queried as appropriate for each assertion type.

In certain embodiments, the source record lookup module 1330 maintains mappings between assertion types and relevant data sources, enabling efficient identification of appropriate databases for each assertion category. The lookup process may also verify that located source records support the assertion values, flagging discrepancies for review.

An evidence link generator 1340 associates each factual assertion with references to supporting source records. Evidence links may comprise database identifiers, record identifiers, timestamps, and access paths enabling retrieval of source records. The evidence link format may be adapted based on the presentation context, providing detailed identifiers for programmatic access or simplified references for user display.

A response with evidence links output represents the final response including embedded evidence links. The evidence links enable fleet safety managers to verify response accuracy against primary data sources, addressing concerns regarding potential inaccurate outputs from language model systems. Verification may be performed through the fleet management user interface 190, which may provide interactive access to source records referenced by evidence links.

In certain embodiments, the evidence link generation process generates uncertainty indicators for assertions lacking corresponding source records. Uncertainty indicators include explanatory text indicating data limitations, enabling users to understand the basis for and confidence in response content. Data limitations may include incomplete data coverage for requested time periods, such as when GPS data is unavailable for portions of a route due to connectivity gaps; source system latency, such as when the most recent hours-of-service data has not yet synchronized from electronic logging devices; data quality issues identified during integration, such as timestamp inconsistencies or missing required fields; and scope limitations, such as when requested analysis spans time periods predating system deployment. Uncertainty indicator text may specify the nature of the limitation, the affected assertions, and where applicable, the expected availability of complete data.

A computer program product may include a non-transitory computer-readable medium having instructions stored thereon, the instructions being executable by one or more processors configured to carry out any of the systems and/or methods described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, etc.

The actual software code or specialized control hardware used to implement these systems and methods does not limit the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The operations described in this specification can be implemented as operations performed by a data processing apparatus on data stored on one or more computer-readable storage devices or received from other sources.

The terms “data processing apparatus”, “data processing system”, “client device”, “client computing device”, “computing platform”, “computing device”, “computing system”, “user device”, or “device” can encompass all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read-only memory or a random access memory or both. The elements of a computer include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a GPS receiver, a digital camera device, a video camera device, or a portable storage device (e.g., a universal serial bus (USB) flash drive), for example. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), plasma, or LCD monitor, for displaying information to the user; a keyboard; and a pointing device, e.g., a mouse, a trackball, or a touchscreen, by which the user can provide input to the computer. Other kinds of devices can be used to provide for interaction with a user as well; for example, feedback provided to the user can include any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user.

In certain circumstances, multitasking and parallel processing systems may be advantageous. Moreover, the separation of various system components in the implementations described above should not be understood as requiring such separation in all implementations, and it should be understood that the described program components and systems can generally be integrated together in a single software product or packaged into multiple software products. For example, the computing devices described herein can each be a single module, a logic device having one or more processing modules, one or more servers, or an embedded computing device.

Having now described some illustrative implementations and implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements, and features discussed only in connection with one implementation are not intended to be excluded from a similar role in other implementations or implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act, or element may include implementations where the act or element is based at least in part on any information, act, or element.

Any implementation disclosed herein may be combined with any other implementation, and references to “an implementation,” “some implementations,” “an alternate implementation,” “various implementation,” “one implementation,” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms.

Where technical features in the drawings, detailed description or any claim are followed by reference signs, the reference signs have been included for the sole purpose of increasing the intelligibility of the drawings, detailed description, and claims. Accordingly, neither the reference signs nor their absence have any limiting effect on the scope of any claim elements.

The preceding description of the disclosed embodiments is provided to enable any person skilled in the art to make or use the embodiments described herein and variations thereof. Various modifications to these embodiments will be readily apparent to those skilled in the art, and the principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A method for processing fleet safety queries, comprising:
receiving, at one or more processors, a natural language query regarding fleet safety data;
analyzing, using a first machine learning model, whether the natural language query matches any predetermined query patterns;
upon determining the query does not match any predetermined patterns:
generating, using a second machine learning model, a proposed data retrieval plan;
identifying data sources required to fulfill the proposed plan;
retrieving data from the identified sources; and
generating a response including the retrieved data; and
providing supporting evidence links associated with factual assertions in the response.

2. The method of claim 1, wherein analyzing whether the natural language query matches any predetermined query patterns comprises:
generating a vector representation of the natural language query by encoding semantic features of the query into a multi-dimensional embedding space;
comparing the vector representation against a query pattern database storing previously processed query vectors; and
computing a similarity metric between the vector representation and each stored query vector.

3. The method of claim 1, wherein generating the proposed data retrieval plan comprises:
generating a structured data retrieval plan that specifies target database tables, query parameters, join conditions linking disparate data sources, and temporal filters.

4. The method of claim 3, wherein retrieving data from the identified sources comprises:
executing the structured data retrieval plan to retrieve fleet safety data from a plurality of data sources, wherein the plurality of data sources comprises at least two of: a GPS tracking database, a vehicle telemetry database, a video event database, or a driver performance database; and
integrating retrieved data from the plurality of data sources by correlating records based on temporal proximity and vehicle identifiers.

5. The method of claim 1, wherein generating the response further comprises:
identifying, within the retrieved data, safety-related data elements, wherein safety-related data elements comprise at least one of: collision event records, driver alert violations exceeding a severity threshold, hours-of-service compliance deviations, or vehicle maintenance fault codes;
executing a verification operation against a primary data source to confirm accuracy of each identified safety-related data element; and
generating a confidence indicator for each safety-related data element based on verification results.

6. The method of claim 1, further comprising:
analyzing a complexity score for the natural language query based on a count of distinct data sources required to fulfill the query, a count of distinct entity types referenced, and a count of temporal constraints specified;
in response to the complexity score exceeding a complexity threshold:
identifying temporal relationships between data records from different sources based on timestamp alignment within a configurable temporal window;
detecting data inconsistencies across sources by comparing overlapping data fields; and
generating a data consistency score for integrated retrieved data.

7. The method of claim 1, further comprising:
storing the proposed data retrieval plan in a query pattern database for subsequent pattern matching operations, wherein storing comprises:
extracting analysis parameters from the natural language query comprising entity types, temporal ranges, and aggregation functions;
recording metadata identifying each data source accessed; and
associating verification requirements with the stored plan based on data sensitivity classifications.

8. The method of claim 1, further comprising:
detecting, from the natural language query, a request for time-sensitive safety information based on presence of urgency indicators;
in response to detecting the request for time-sensitive safety information, routing the query to a dedicated processing pathway configured to bypass pattern matching and directly access real-time data feeds.

9. The method of claim 1, wherein the response further comprises uncertainty indicators for assertions lacking corresponding source records, wherein each uncertainty indicator includes explanatory text indicating data limitations.

10. The method of claim 1, further comprising:
receiving feedback data indicating user assessment of the response; and
adjusting a relevance weight associated with query patterns based on the feedback data.

11. The method of claim 1, further comprising:
upon generating the response, storing the natural language query in a query tracking database associated with a fleet identifier of an originating fleet management terminal;
periodically analyzing the query tracking database to identify query patterns that exceed a predetermined frequency threshold across a plurality of fleet management terminals;
generating user interface component specifications based on the identified query patterns;
computing a cluster priority score for each identified query pattern based on a weighted combination of cluster size, aggregate fleet size of contributing fleets, and aggregate safety performance scores of contributing fleets; and
ranking generated user interface component specifications by cluster priority score.

12. The method of claim 11, wherein computing the cluster priority score comprises:
retrieving, for each fleet contributing queries to a query pattern cluster, a computed safety score derived from collision rates, alert frequencies, and compliance metrics; and
applying elevated weighting to query contributions from fleets having safety scores exceeding a performance threshold.

13. The method of claim 12, further comprising:
determining fleet similarity between fleets associated with the plurality of fleet management terminals by representing each fleet profile as a vector encoding fleet size category, operational category, primary geographic region, and cargo type classification;
computing a distance metric between fleet profile vectors; and
distributing generated user interface component specifications to fleet management terminals associated with fleets having distance metrics below a similarity threshold.

14. The method of claim 1, further comprising:
prior to generating the response, analyzing the natural language query to determine whether requested analysis complies with predetermined operational guidelines by:
parsing the natural language query to identify requested analysis parameters comprising target data fields, aggregation dimensions, and filter criteria;
comparing the requested analysis parameters against a compliance rule database storing prohibited analysis patterns; and
generating a compliance risk score based on matching between requested analysis parameters and prohibited analysis patterns;
in response to the compliance risk score exceeding a compliance threshold, generating an alternative query that achieves safety-related analytical objectives while avoiding prohibited analysis patterns and processing the alternative query in place of the natural language query; and
logging the natural language query, compliance assessment, and the response in an audit database.

15. The method of claim 14, further comprising:
analyzing terminology used in the natural language query against a terminology guidance database storing term pairs comprising disfavored terms and preferred alternative terms;
detecting presence of disfavored terms in the natural language query;
generating a terminology suggestion comprising the preferred alternative term and an explanatory rationale; and
presenting the terminology suggestion prior to generating the response;
wherein the terminology guidance database stores term pairs comprising:
a first term pair mapping a collision-related disfavored term to a preferred neutral term; and
a second term pair mapping a driver qualification disfavored term to a preferred standard-of-care-neutral term.

16. The method of claim 1, further comprising:
subsequent to generating the response, computing a query abstraction of the natural language query that preserves analytical intent while removing fleet-identifying information, wherein computing the query abstraction comprises:
extracting semantic features from the natural language query;
identifying named entities in the natural language query comprising driver names, vehicle identifiers, location names, and customer references;
replacing identified named entities with categorical tokens indicating entity type without specific identity; and
normalizing numerical values referenced in the natural language query to categorical ranges; and
storing the query abstraction in a community knowledge database aggregating abstracted query representations from a plurality of fleet management systems.

17. The method of claim 16, further comprising:
periodically analyzing the community knowledge database to identify high-value query patterns based on correlation between query patterns and fleet safety performance improvements, wherein identifying comprises:
tracking safety performance metrics for fleets subsequent to query submission;
computing correlation coefficients between query pattern occurrence and safety metric improvements; and
classifying query patterns having correlation coefficients exceeding a correlation threshold as high-value query patterns.

18. The method of claim 17, further comprising:
identifying source fleets having safety performance metrics in a top performance tier;
applying elevated weighting to queries from top-tier fleets when computing correlation coefficients;
generating best-practice query collections comprising high-value query patterns predominantly contributed by top-tier fleets; and
transmitting suggested query templates derived from the best-practice query collections to target fleet management systems based on contextual applicability criteria.

19. A system for processing fleet safety queries, comprising:
one or more processors; and
a memory coupled to the one or more processors and storing instructions that, when executed by the one or more processors, cause the system to:
receive a natural language query regarding fleet safety data;
analyze, using a first machine learning model, whether the natural language query matches any predetermined query patterns;
upon determining the query does not match any predetermined patterns:
generate, using a second machine learning model, a proposed data retrieval plan;
identify data sources required to fulfill the proposed plan;
retrieve data from the identified sources; and
generate a response including the retrieved data; and
provide supporting evidence links associated with factual assertions in the response.

20. A non-transitory computer-readable medium storing instructions that, when executed by one or more processors, cause the one or more processors to perform operations comprising:
receiving a natural language query regarding fleet safety data;
analyzing, using a first machine learning model, whether the natural language query matches any predetermined query patterns;
upon determining the query does not match any predetermined patterns:
generating, using a second machine learning model, a proposed data retrieval plan;
identifying data sources required to fulfill the proposed plan;
retrieving data from the identified sources; and
generating a response including the retrieved data; and
providing supporting evidence links associated with factual assertions in the response.
